(19) United States
(12) Patent Application Publication
(10) Pub. No.: US 2018/0049164 A1
(43) Pub. Date: Feb. 15, 2018

(54) TRANSMISSION METHOD BASED ON PHYSICAL DOWNLINK CHANNEL, USER EQUIPMENT, AND BASE STATION

(71) Applicant: MediaTek Singapore Pte. Ltd.

(72) Inventors: Min WU, Beijing (CN); Feifei SUN, Beijing (CN); Lei ZHANG, Beijing (CN)

(21) Appl. No.: 15/554,292

(22) PCT Filed: Jan. 11, 2017
(86) PCT No.: PCT/CN2017/070838

§ 371 Date: Aug. 29, 2017

(30) Foreign Application Priority Data
Jan. 11, 2016 (CN) 201610015174.4
Feb. 5, 2016 (CN) 201610081948.3

(51) Int. Cl. H04W 72/04; H04W 72/12; H04W 74/08

(52) U.S. Cl. CPC H04W 72/042; H04W 74/0833; H04W 72/12

(57) ABSTRACT

Transmission methods, user equipment, and base stations based on a physical downlink channel are provided, the method including the steps of receiving control information carried by the physical downlink channel, the control information including a time interval indication, and determining information of uplink resource associated with a user equipment (UE) or a starting subframe of the scheduling window based on the time interval indication and an ending subframe of the physical downlink channel. The present invention provides a time domain resource allocation method based on a scheduling window to facilitate the flexible allocation of time domain resources for a plurality of UEs.

### CROSS REFERENCE TO RELATED APPLICATIONS

This Application claims the priority of China Patent Application Nos. CN201610015174.4, filed on Jan. 11, 2016, and CN201610081948.3, filed on Feb. 5, 2016, the entireties of which are incorporated by reference herein.

### BACKGROUND OF THE INVENTION

### Field of the Invention

The invention generally relates to wireless communication, and more particularly, to a transmission method for indicating a scheduling delay based on a physical downlink channel.

### Description of the Related Art

With the rapid development of the cellular mobile communication industry, 5th-generation (5G) mobile communication system has received more attention and research focus. Recently, 5G is now officially named IMT-2020 by ITU, which is expected to enter the commercial phase by 2020. Unlike traditional 2G/3G/4G mobile cellular systems, 5G will no longer be for human users only, as it will support a wide variety of “machine type communication” (hereinafter also referred to as MTC) users. Among the many services in the MTC user equipment business, there is a type called Massive MTC (hereinafter referred to as MMC). The main features of the business providing this service to MTC user equipment include: (1) low costs. User equipment costs are far lower compared to smart phones; (2) the quantity is large. In reference to ITU's 5G requirements and targeting MMC business, 10⁶ connections per square kilometer are supported; (3) low data transfer rate requirements; (4) high latency tolerance, and so on.

In cellular communication for traditional user equipment, the cell coverage of 99% is usually considered during system design. For the remaining 1% of users uncovered, they may utilize the mobility of equipment itself to obtain services through cell selection or cell reselection. Unlike human-oriented communication user equipment, some types of MMC user equipments may be deployed in relatively fixed locations, such as MTC user equipment offering services in public facilities (e.g., street lights, water meter, electricity meter, gas meter, etc.). This type of MMC user equipments possesses almost no mobility. Therefore, during the process of MMC communication system design, the cell coverage requirement is usually above 99.99% or more. Even worse, this type of MMC users may be deployed in scenes such as a basement with serious path loss. Hence, in order to obtain better support coverage, target Maximum Coupling Loss (hereinafter also referred to as MCL) used in the MMC system design is usually 10 dB-20 dB bigger than the traditional cellular system. For example, in undergoing Narrow Band Internet-of-Things (hereinafter also referred to as NB-IoT) system standardization work, the cell MCL target is 164 dB or higher.

In the NB-IoT system, since the occupying band is narrow, the number of subcarriers available in the frequency domain is very limited. For example, when a subcarrier interval of 15 kHz is adopted, only 12 subcarriers are included in the 180 kHz bandwidth. Considering compatibility with the LTE system, only 14 OFDMA symbols (downlink) or SC-FDMA symbols (uplink) are included in a subframe. That is, at most 168 resource elements (hereinafter also referred to as RE) can be allocated in each subframe. In order to support larger physical Transport Blocks (hereinafter also referred to as TB), (e.g. when the Transport Block Size (hereinafter also referred to as TBS) reaches 1000 bits), it is necessary to allocate multiple subframes in the time domain for a TB. Taking into account the flexibility of the time domain's resource scheduling, the allocation of a set of time domain resources for a TB based on a scheduling window is considered a suitable method.

A time domain scheduling window consists of many subframes. A base station may perform a scheduling decision in each scheduling window to allocate all the subframes in the scheduling window for a set of user equipment (hereinafter also referred to as UE) or multiple UEs. The scheduling window and traditional scheduling bandwidth (BD) based on frequency domain resource allocation share a similar concept, which involves moving the concept from frequency domain to time domain. In one scheduling decision, the scheduling bandwidth may achieve Frequency Domain Multiplexing (hereinafter also referred to as RDM) for multiple UEs, while the scheduling window may achieve Time Domain Multiplexing (hereinafter also referred to as TDM) for multiple UEs. Such time domain resource allocation method based on the scheduling window facilitates the flexible allocation of time domain resources for multiple UEs. In view of this, the present invention provides a resource allocation method for allocating a set of time domain resource units based on a scheduling window.

### BRIEF SUMMARY OF THE INVENTION

Accordingly, embodiments of the invention provide transmission methods and user equipment based on a physical downlink channel.

In one novel aspect, a transmission method based on a physical downlink channel is provided, the method comprising: receiving control information carried by the physical downlink channel, wherein the control information including a time interval indication; and determining information of uplink resource associated with a user equipment or a starting subframe of a scheduling window based on the time interval indication and an ending subframe of the physical downlink channel. In one embodiment, the control information is a Random Access Response (RAR) message and the physical downlink channel is a Physical Downlink Shared Channel (PUSCH) carrying the RAR information; and a starting subframe for transmitting a message 3 (hereinafter also referred to as Msg3) is determined based on the time interval indication and an ending subframe of the Physical Downlink Shared Channel (PDSCH). In one embodiment, the MAC Control Element (hereinafter also referred to as MAC CE) in the RAR information indicates the time interval.

In another novel aspect, a user equipment is provided. The user equipment comprises a wireless transceiver and a controller. The wireless transceiver is configured to perform wireless transmission with at least one base station. The controller is connected to the wireless transceiver. The controller is configured to receive control information carried by a physical downlink channel from the at least one base station, the control information including a time interval indication. The controller determines information of uplink resource associated with a user equipment or a starting subframe of a scheduling window based on the time interval indication and an ending subframe of the physical downlink channel.

In another novel aspect, a base station is provided. The base station comprises a wireless transceiver and a controller. The wireless transceiver is configured to perform wireless transmission with at least one user equipment. The controller is connected to the wireless transceiver. The controller is arranged in the control information carried by the physical downlink channel to indicate a time interval indication such that the at least one user equipment determines information of uplink resource associated with the at least one user equipment or a starting subframe of the scheduling window based on the time interval indication in the control information and an ending subframe of the physical downlink channel.

In another novel aspect, a resource allocation method for scheduling a set of time domain resource units based on a scheduling window is provided, wherein the method comprises: the user equipment receiving a Downlink Control Information (hereinafter also referred to as DCI) of a physical transport block (hereinafter also referred to as TB), wherein a Resource Allocation (hereinafter also referred to as RA) field in the DCI indicates a set of time domain resource units within a time domain scheduling window; and then the user equipment performing transmission operations of the TB, such as receiving or transmitting, on the set of time domain resource units. In one embodiment, the time domain resource unit is a subframe. In another embodiment, the time domain resource unit is a plurality of subframes. In one embodiment, a set of time domain resource units allocated are contiguous. In another embodiment, a set of time domain resource units allocated are non-continuous.

In yet another novel aspect, a processing method for processing an unavailable subframe which is unavailable for resource allocation within a duration of a scheduling window is provided, wherein the method comprises: the user equipment determines whether each subframe within the duration of the scheduling window is an unavailable subframe; if the subframe is an unavailable subframe, a predefined processing method is used. In one embodiment, the predefined processing method is that: if the subframes schedulable within the scheduling window include unavailable subframes, the number of actually available subframes may be less than the number of allocated subframes, and data transmissions which are originally mapped to the unavailable subframes are discarded or the rate matching is performed according to the number of actual available subframes to avoid the unavailable subframes. In another embodiment, the predefined processing method is that: if the schedulable subframe excludes an unavailable subframe, the number of actual available subframes is equal to the number of allocated subframes, and data transmissions which are originally mapped to the unavailable subframes are delayed to the next available subframe.

In yet another novel aspect, a method of determining a position of a starting subframe of a scheduling window is provided, wherein the method comprises: the user equipment receives a Physical Downlink Control Channel (PDCCH) that allocates a set of time domain resource units based on a scheduling window; the user equipment further determines the position of the starting subframe of the scheduling window according to a predefined rule to determine the absolute positions of a set of time domain resource units allocated within the scheduling window. In one embodiment, the predefined rule is that the position of the starting subframe of the scheduling window is determined by an ending subframe corresponding to the Physical Downlink Control Channel (PDCCH) or by the ending subframe of the search space containing the corresponding PDCCH, or by the ending subframe of the control area containing the corresponding PDCCH. In another embodiment, the predefined rule is that the position of the starting subframe of the scheduling window is determined by a subframe number, a frame number, and the number of subframes included in the scheduling window, and a control area and a physical downlink data area are included in each downlink scheduling window, the physical downlink control channel and the scheduled set of time domain resource units belong to the same scheduling window or different scheduling windows. In another embodiment, a plurality of scheduling windows included within a given time are numbered, and the number for the scheduling window is used to involve in the initialization of a scrambling sequence generator used for the corresponding physical data channel transmission.

In yet another novel aspect, a method of designing content of a Resource Allocation (RA) field in a DCI is provided, wherein the method comprises: the RA field of the DCI comprising at least one or more of the following information: the positions of time domain resource units allocated within a time domain scheduling window; the number of time domain resource units allocated within a time domain scheduling window; the positions of frequency domain resource units allocated within a frequency domain scheduling bandwidth; and the number of frequency domain resource units allocated within a frequency domain scheduling bandwidth. In one embodiment, the number of frequency domain resource units allocated within a frequency domain scheduling bandwidth is fixed to one frequency domain resource unit, the position of the frequency domain resource unit in the scheduling bandwidth may be indicated in the RA or configured through higher layer signaling. In another embodiment, the maximum number of frequency domain resource units included in the fix allocated frequency domain scheduling bandwidth is the number of frequency domain resource units allocated within the frequency domain scheduling bandwidth and positions of which are no need to be indicated in RA.

In yet another novel aspect, a method of repeating a physical data channel based on a scheduling window is provided, wherein the method comprises: the physical data channel repeating transmissions over the same set of time domain resource units of a plurality of scheduling windows, and if the number of time domain resource units occupied is less than the maximum number of time domain resource units in the scheduling window, it is discontinuously repeated. In one embodiment, the PDCCH and the scheduled physical data channel are repeatedly transmitted within a plurality of scheduling windows, and time relationship between the first physical data channel repetition and the last PDCCH repetition is same-window scheduld (or intra-window scheduling) or cross-window scheduled (or inter-window scheduling). In another embodiment, the PDCCH and the scheduled physical data channel are continuously repeated, and the time relationship between the first physical data channel repetition and the last physical downlink control channel repetition are determined by the scheduling window.

According to still another novel aspect, a method of scheduling a message 3 (Msg3) is provided, which comprises determining the timing of Msg3 according to a Random Access Response (hereinafter referred to as RAR), and providing resource allocation for Msg3 in a different number of tones (tone/subcarrier) in frequency domain and the time domain. In one implementation, UE determines a size of the tone according to the DCI, e.g., the UE first obtains the number of tones in the DCI field, and then obtains the resource size for resource allocation in the field. For multi-tone cases, for example, if 12 carriers are obtained from the DCI, 4 plus 4 bits are allocated to indicate the time domain resource allocation and no bits are allocated for the indication for the RA in the frequency domain. If a single tone is obtained from the DCI, 4 bits are allocated to indicate the time domain resource, and 4 bits are allocated to indicate the RA in the frequency domain.

According to still another novel aspect, a method for a UE to obtain a scheduling resource is provided, the method comprising: obtaining a frequency domain scheduling information by parsing a first field in the DCI; determining the number of bits in a second field within the DCI and parsing the second field and obtaining time domain scheduling information based on the frequency domain scheduling information. Wherein the frequency domain scheduling information is the number of subcarriers. In one embodiment, the time domain scheduling information is a starting position of a scheduling window, or a serial number for the scheduling window. In another embodiment, the time domain scheduling information is the time domain starting position of the scheduled resource.

Other embodiments and advantages of the transmission method and the user equipment based on physical downlink channel will be described in detail below. The “Brief Summary of the Invention” part is not intended to limit the invention, and the scope of the invention is defined by the claims.

### BRIEF DESCRIPTION OF DRAWINGS

The invention can be more fully understood by reading the subsequent detailed description and examples with references made to the accompanying drawings, in which like numerals refer to like elements in the drawings, wherein:

FIG. 1 is a block diagram illustrating a wireless communication environment according to an embodiment of the invention;

FIG. 2 is a block diagram illustrating a wireless communication device 200 according to an embodiment of the invention;

FIG. 3 is a block diagram illustrating a base station 300 according to an embodiment of the present invention;

FIG. 4 shows a flow chart illustrating the transmission method based on a physical downlink channel method according to an embodiment of the invention;

FIG. 5 shows a flow chart illustrating the time domain resource allocation method based on a scheduling window according to an embodiment of the present invention;

FIG. 6 is an exemplary diagram illustrating the time domain scheduling window according to an embodiment of the invention, wherein the time domain resource unit is a subframe;

FIG. 7 is an exemplary diagram illustrating the time domain scheduling window according to an embodiment of the invention, wherein the time domain resource unit is multiple subframes;

FIG. 8 is an exemplary diagram illustrating the continuous allocation of a set of time domain resource units within a time domain scheduling window according to an embodiment of the invention;

FIG. 9 is an exemplary diagram illustrating the non-contiguous allocation of a set of time domain resource units within a time domain scheduling window according to an embodiment of the invention;

FIG. 10 is an exemplary diagram illustrating the time domain scheduling window including an unavailable subframe according to an embodiment of the invention;

FIG. 11 is an exemplary diagram illustrating the time domain scheduling window excluding an unavailable subframe according to an embodiment of the invention;

FIG. 12 is an exemplary diagram illustrating the starting position of the time domain scheduling window being determined by the end position of the corresponding physical downlink control channel according to an embodiment of the invention;

FIG. 13 is an exemplary diagram illustrating the starting position of the time domain scheduling window being determined by the end position of the search space including the corresponding physical downlink control channel according to an embodiment of the present invention;

FIG. 14 is an exemplary diagram illustrating the starting position of the time domain scheduling window being determined by the end position of the control area including the corresponding physical downlink control channel according to an embodiment of the invention;

FIG. 15 is an exemplary diagram illustrating the starting position of the time domain scheduling window being determined by the subframe number, the frame number, and the number of subframes included in the scheduling window according to an embodiment of the invention;

FIG. 16 is an exemplary diagram illustrating the numbering of a plurality of scheduling windows within a given time period and the initialization of the scrambling sequence generator using the number for the scheduling window according to an embodiment of the invention;

FIG. 17 is an exemplary diagram illustrating a downlink scheduling window including a physical downlink control area and a physical downlink data area, and performing a same-window scheduling for downlink and performing a cross-window scheduling for uplink according to an embodiment of the invention;

FIG. 18 is an exemplary diagram illustrating the situation that the number of subframes in the downlink scheduling window is different from that in the uplink scheduling window while the duration of the downlink scheduling window is the same the duration of the uplink scheduling window according to an embodiment of the invention;

FIG. 19 is an exemplary diagram illustrating the situation that the duration of the DLscheduling window is different from the duration of the UL scheduling window while the number of subframes in the DL scheduling window are the same that in the UL scheduling window according to an embodiment of the invention;

FIG. 20 is an exemplary diagram illustrating a resource allocation method based on a single-tone transmission mode and a scheduling window according to an embodiment of the invention;

FIG. 21 is an exemplary diagram illustrating a resource allocation method based on a multi-tone transmission mode and a scheduling window according to an embodiment of the invention;

FIG. 22 is an exemplary diagram illustrating a resource allocation method based on a full-tone transmission mode and a scheduling window according to an embodiment of the invention;

FIG. 23 is an exemplary diagram illustrating the resources of time domain are indicated by the position of the scheduling resource and an offset according to an embodiment of the invention;

FIG. 24 is a schematic diagram illustrating the discontinuous repetition of both the physical downlink control channel and the scheduled physical downlink data channel according to an embodiment of the invention;

FIG. 25 is a schematic diagram illustrating the continuous repetition of a physical downlink control channel and the discontinuous repetition of the scheduled physical downlink data channel according to an embodiment of the invention; and

FIG. 26 is a schematic diagram illustrating the continuous repetition of the physical downlink control channel and the continuous repetition of the scheduled physical downlink data channel according to an embodiment of the invention.

### DETAILED DESCRIPTION OF THE INVENTION

The foregoing and other features of the embodiments of the present invention will become apparent from the following description with reference made to the accompanying drawings. These embodiments are made for the purpose of illustrating the general principles of the invention and should not be taken in a limiting sense. For easily understanding the principles and implementations of the invention by those who are skilled in this technology, the embodiments of the present invention will be described with reference to the LTE carrier and the Massive MTC (hereinafter also referred to as MMC) communication system, for example. However, it is understood that the embodiments of the present invention are not limited to the above-described scenes, and are applicable to other scenes relating to the transmission capability indication and transmission mode configuration.

In the embodiments of the present invention, the term “scheduling window” is for convenience of explanation, and other expressions in this technology such as “scheduling subframe”, “scheduling frame”, “super-subframe” and so on may also be used. The embodiments of the present invention are not limited thereto. The transmission modes for “single-tone”, “multi-tone” and “full-tone” may also be referred to as “single carrier”, “single subcarrier”, “multi-carrier” , “multi-subcarrier”, “full carrier”, “full subcarrier”, etc., the invention is not limited thereto. The term “time domain resource unit” may also be referred to as “subframe”, “minimum transmission time interval (hereinafter also referred to as TTI)”, and the like, and the invention is not limited thereto. The term “frequency domain resource unit” may also be referred to as a “subcarrier”, a “physical resource block (hereinafter referred to as PRB)”, a PRB peer, and the like, and the invention is not limited thereto.

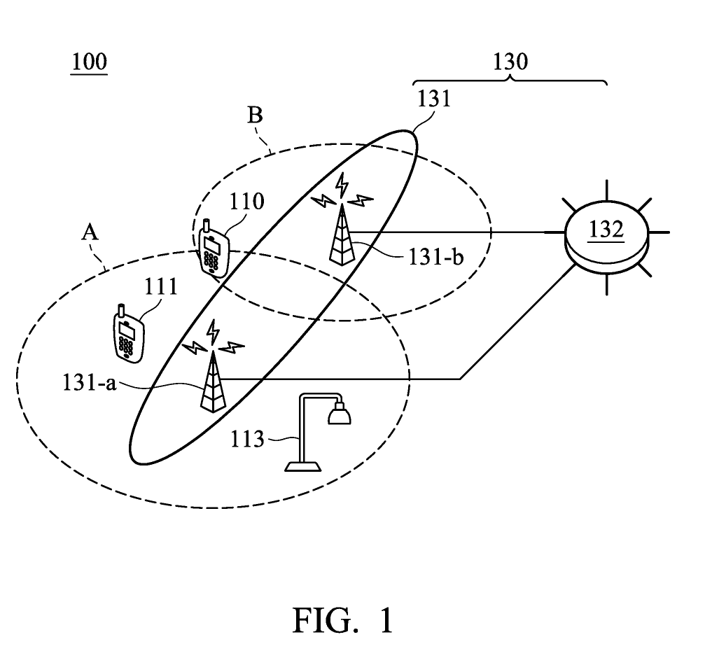

FIG. 1 is a block diagram illustrating a wireless communication environment according to an embodiment of the invention. In one embodiment, the wireless communication environment 100 includes a plurality of wireless communication devices (e.g., the wireless communication device 110, the wireless communication device 111 and the wireless communication device 113 as shown in FIG. 1) and a serving network 130. The wireless communication device 110, the wireless communication device 111, and the wireless communication device 113 are wirelessly connected to the serving network 130 to obtain a mobility service. Each of the wireless communication device 110, the wireless communication device 111, and the wireless communication device 113 may be referred to as a user equipment (UE). In one embodiment, the wireless communication device 110 and the wireless communication device 111 may be mobile devices having mobility functionality, such as functional handsets, smartphones, personal tablet computers, notebook computers, or other computing device supporting the wireless communication technology utilized by the serving network 130. In another embodiment, the wireless communication device 113 may be a user equipment having no mobility functionality or low mobility functionality. For example, it may be a user equipment that is deployed in a relatively fixed position to serve the MMC. To be more specific, it may be a user equipment applied to a public facility (e.g., a street lamp, a water meter, a meter, a gas meter, etc.), or a user equipment applied to a domestic facility (e.g., a desk lamp, an oven, a washing machine, a refrigerator, etc.) and so on. Such user equipment serving the MMC/MTC (e.g., the wireless communication device 113) has little movement characteristics.

In one embodiment, the serving network 130 may be LTE/LTE-A/LTE-U (LAA)/TD-LTE/5G/IOT/LTE-M/NB-IoT/EC-GSM/WiMAX/W-CDMA network and so on. The serving network 130 includes an access network 131 and a core network 132. The access network 131 is responsible for processing the radio signals, implementing the radio protocol and connecting the wireless communication device 110, the wireless communication device 111, and the core network 132. The core network 132 is responsible for performing mobility management, network-side authentication, and serving as an interface of a public/external network (e.g., the Internet).

In one embodiment, each of the access network 131 and the core network 132 may include one or more network nodes with the above-mentioned functionality. For example, the access network 131 may be a Evolved Universal Terrestrial Radio Access Network (hereinafter also referred to as E-UTRAN) that includes at least two evolved NodeBs (e.g., a macro cell/macro ENB, a small base station (Pico cell/pico ENB), or a femtocell/femto base station), the core network 132 may include an Evolved Packet Core (hereinafter also referred to as EPC) belong to a Home Subscriber Server (hereinafter also referred to as HSS), a Mobility Management Entity (hereinafter also referred to as MME), a Service Gateway (hereinafter also referred to as S-GW) and a Data Packet Network Gateway (hereinafter also referred to as PDN-GW or P-GW), and the invention is not limited thereto.

As shown in FIG. 1, the wireless communication device 110 is located within the coverage area of a cell A and within the coverage area of a cell B. That is, the wireless communication device 110 is located within a coverage area overlapping the cell A and the cell B. The wireless communication device 111 is located only within the coverage area of the cell A. The access network 131 may include an eNB 131-a and an eNB 131-b serving the cells A and B, respectively. The eNB 131-a and the eNB 131-b may be cellular base stations that communicate with the user equipment. The eNB may be a cellular station that communicates wirelessly with a plurality of user equipments and may also be a base station, an access point (AP), or the like. Each eNB provides a specific communication coverage for a particular geographic area. In 3GPP, a “cell” may be considered as the specific communication coverage of an eNB.

In one embodiment, the access network 131 may be a heterogeneous network (hereinafter also referred to as HetNet). HetNet includes different types of eNBs, such as large base stations, small base stations, femtocells, relay stations, and the like. The large base station may cover relatively large geographic areas (e.g., geographic areas with a radius of several kilometers) and allow unlimited access to subscribe services between user equipments and network providers. The small base station may cover a relatively small geographical area and allow unlimited access to the subscribe service between the user equipment and the network provider. The femtocell base station may cover a relatively small geographical area (e.g., home or small office) provided in the residential type, and in addition to unlimited access, the femtocell base station may also provide restricted access for the user equipment associated with the femtocell base station (e.g., a user equipment in a Closed Subscriber Group (hereinafter also referred to as CSG), a user equipment used by a user in home, etc.).

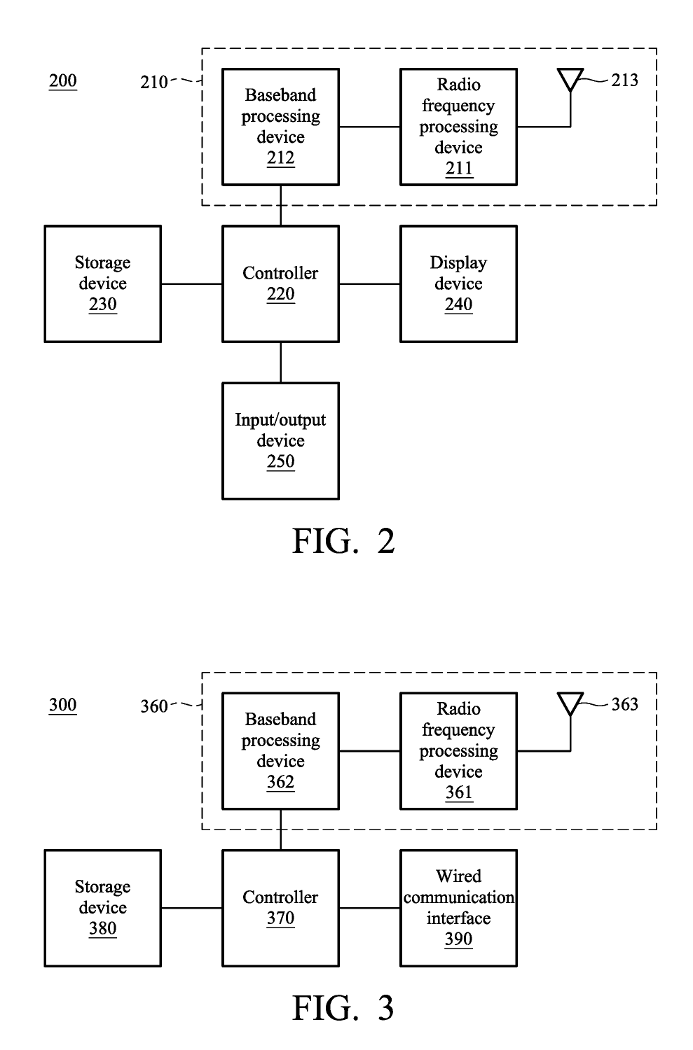

FIG. 2 is a block diagram illustrating a wireless communication device 200 according to an embodiment of the invention. The wireless communication device 200 may be the user equipment as shown in the embodiment of FIG. 1. The wireless communication device 200 comprises a wireless transceiver 210, a controller 220, a storage device 230, a display device 240, and an input/output device 250, wherein the controller 220 is separately connected to the wireless transceiver 210, the storage device 230, the display device 240, and the input/output device 250.

In one embodiment, the wireless transceiver 210 is configured to perform wireless transmission, and transmission and reception with the access network 131 and includes interference cancellation and suppression receiver. The wireless transceiver 210 comprises a radio frequency (RF) processing device 211, a Baseband processing device 212, and an antenna 213. The RF processing device 211 is connected to the Baseband processing device 212 and the antenna 213, respectively. In this embodiment, the receiving end of the RF processing device 211 may receive baseband signals from the Baseband processing unit 212 and convert the received baseband signals to RF wireless signals, which are later transmitted via the antenna 213, wherein the radio frequency of RF wireless signals may be 900 MHz, 2100 MHz or 2.6 GHz utilized in LTE/LTE-A/TD-LTE technology, or may be 1800 MHz, 900 MHz or 800 MHz or 700 MHz utilized in NB-IoT/LTE-M technology, or others, depending on the wireless technology in use. In this embodiment, the transmission end of the RF processing device 211 includes at least a power amplifier, a Mixer and a low-pass filter, but the invention is not limited thereto.

In one embodiment, the receiving end of the RF processing device 211 receives RF wireless signals via the antenna 213 and converts the received RF wireless signals into Baseband signals to be processed by the Baseband processing device 212, wherein the radio frequency of RF wireless signals may be 900 MHz, 2100 MHz or 2.6 GHz utilized in LTE/LTE-A/TD-LTE technology, or may be 1800 MHz, 900 MHz or 800 MHz or 700 MHz utilized in NB-IoT/LTE-M technology, or others, depending on the wireless technology in use. In this embodiment, the receiving end of the RF processing device 211 may include a plurality of hardware devices for processing the radio frequency signals. For example, the receiving end of the radio frequency processing device 211 may include at least a low noise amplifier, a Mixer (or a down converter) and a low pass filter, but the invention is not limited thereto. The low noise amplifier is used for noise processing of the RF wireless signals received from the antenna 213. The mixer is used for performing a down-conversion operation on the RF wireless signals processed by the low noise amplifier.

In one embodiment, the Baseband processing device 212 is configured to perform baseband signal processing and is configured to control communication between a Subscriber Identity Module (SIM) and the RF processing device 211. In one embodiment, the Baseband processing device 212 may comprise a plurality of hardware components to perform the baseband signal processing, such as, an analog-to-digital converter, a digital to analog converter, an amplifier circuit associated with gain adjusting, circuits associated with modulation/demodulation, circuits associated with encoding/decoding and so on.

In one embodiment, the controller 220 may be a general-purpose processor, a Micro Control Unit (hereinafter referred to as an MCU), an application processor, a digital signal processor, or any type of processor control device that processes digital data. The controller 220 includes circuits which provide the function for data processing and computing, the function for controlling the wireless transceiver 210 for wireless communications with the access network 131, the function for storing and retrieving data to and from the storage device 230, the function for sending a series of frame data (e.g. representing text messages, graphics, images or others) to the display device 240 and the function for receiving signals from the input/output device 250. Most importantly, the processor 220 coordinates the above-mentioned operations of the wireless transceiver 210, the storage device 230, the display device 240, and the input and output device 250 to perform the method of the present invention.

In another embodiment, the controller 220 may be integrated into the Baseband processing device 212 as a Baseband processor.

In one embodiment, the storage device 230 may be a non-transitory machine-readable storage medium. The storage device 230 may be a memory, such as a FLASH memory or a Non-volatile Random Access Memory (NVRAM), or a magnetic storage device, such as a hard disk or a magnetic tape, or an optical disc, or any combination thereof for storing instructions/program codes utilized in the method, the applications and/or communication protocols of the invention.

In one embodiment, the display device 240 may be a Liquid Crystal Display (LCD), Light-Emitting Diode (LED) display, or Electronic Paper Display (EPD), etc., for providing a display function. Alternatively, the display device 240 may further comprise one or more touch sensors disposed thereon or thereunder for sensing touches, contacts, or approximations of objects, such as fingers or styluses.

In one embodiment, the input and output device 250 may comprise one or more buttons, a keyboard, a mouse, a touch pad, a video camera, a microphone, and/or a speaker, etc., serving as the Man-Machine Interface (MMI) for interaction with users.

It should be understood that the various components described in the embodiment of FIG. 2 are for illustration purposes only and are not intended to limit the scope of the invention.

FIG. 3 is a block diagram illustrating a base station 300 according to an embodiment of the present invention. The base station 300 includes a wireless transceiver 360, a controller 370, a storage device 380, and a wired communication interface 390, wherein the controller 370 is connected to the wireless transceiver 360, the storage device 380, and the wired communication interface 390, respectively. The detailed descriptions of a RF processing device 361, a Baseband processing device 362, and an antenna 363 of the radio transceiver 360 are similar to the RF processing device 211, the Baseband processing device 212, and the antenna 213 of the wireless transceiver 210 of FIG. 2, and thus, are omitted herein for brevity.

In one embodiment, the controller 370 may be a general-purpose processor, an MCU, an application processor, a digital signal processor, or the like. The controller 370 includes circuits which provide the function for data processing and computing, the function for controlling the wireless transceiver 360 for wireless communications with the wireless communication devices 110, 111 and 113, the function for storing and retrieving data to and from the storage device 380, and the function for transmitting/receiving messages to and from other network entities through the wired communication interface 390. Most importantly, the processor 370 coordinates the above-mentioned operations of the wireless transceiver 360, the storage device 380 and the wired communication interface 390 to perform the method of the present invention.

In another embodiment, the controller 370 may be integrated into the Baseband processing device 362 as a Baseband processor.

As will be appreciated by persons skilled in the art, the circuitry of the controller 220 or the controller 370 will typically comprise transistors that are configured in such a way as to control the operation of the circuitry in accordance with the functions and operations described herein. As will be further appreciated, the specific structure or interconnections of the transistors will typically be determined by a compiler, such as a register transfer language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

In one embodiment, the storage device 380 may be a non-transitory machine-readable storage medium. The storage device 380 may be a memory, such as a FLASH memory or a Non-volatile Random Access Memory (NVRAM), or a magnetic storage device, such as a hard disk or a magnetic tape, or an optical disc, or any combination thereof for storing instructions/program codes utilized in the method, the applications and/or communication protocols of the invention.

In one embodiment, the wired communication interface 390 is responsible for providing functionality to communicate with other network entities (e.g., MME and S-GW) in the core network 132. In one embodiment, the wired communication interface 390 may include a cable modem, an Asymmetric Digital Subscriber Line (hereinafter referred to as ADSL) modem, a Fiber-Optic Modem (hereinafter referred to as FOM), and/or an Ethernet interface.

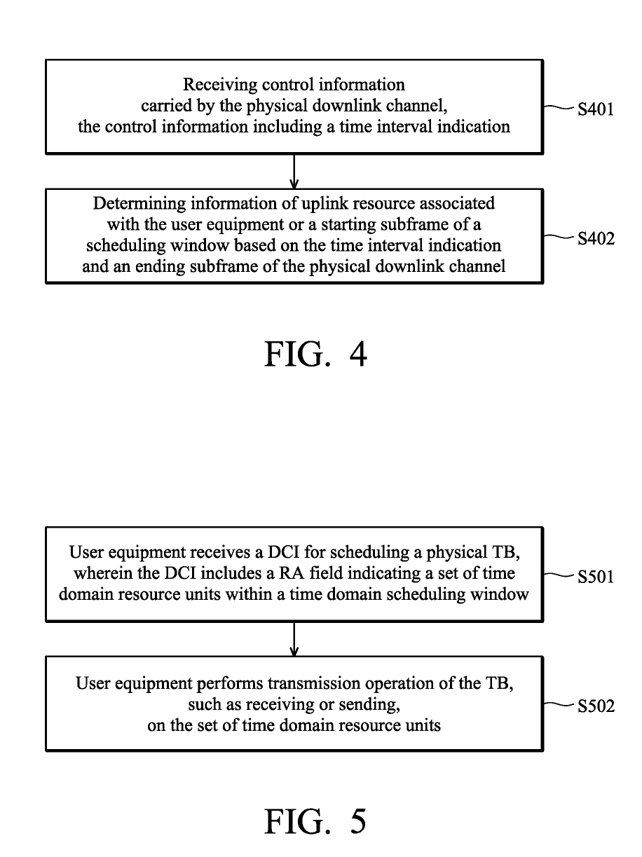

FIG. 4 is a flow chart of a transmission method based on a physical downlink channel. As shown in FIG. 4, in step S401, the wireless communication device 200 (user equipment) receives control information carried by the physical downlink channel, and the control information includes a time interval indication. In step S402, the wireless communication device 200 (user equipment) determines information of uplink resource associated with the wireless communication device 200 or a starting subframe of a scheduling window (user equipment) based on the time interval indication and an ending subframe of the physical downlink channel.

In one embodiment, the wireless transceiver 210 of the user equipment 200 is configured to wirelessly communicate with at least one base station 300. The controller 220 of the user equipment 200 is connected to the wireless transceiver 210. The controller 220 is configured to receive control information carried by a physical downlink channel from the at least one base station 300, the control information including a time interval indication. The controller 220 determines the information about the uplink resource or the starting subframe of the scheduling window for the user equipment 200 based on the time interval indication and the ending subframe of the physical downlink channel.

In one embodiment, the wireless transceiver 360 of the base station 300 is configured to transmit wirelessly with at least one user equipment 200. The controller 370 of the base station 300 is connected to the wireless transceiver 360. The controller 370 is configured to indicate in the control information carried by the physical downlink channel the time interval indication such that the at least one user equipment 200 determines the information about the uplink resource or the starting subframe of the scheduling window for the user equipment 200 based on the time interval indication and the ending subframe of the physical downlink channel.

### Embodiment 1

FIG. 5 shows a flow chart illustrating the time domain resource allocation method based on a scheduling window according to an embodiment of the present invention. As shown in FIG. 5, a resource allocation method for allocating a set of time domain resource units based on a scheduling window is provided. In step S501, the user equipment receives a DCI for scheduling a physical TB, wherein the DCI includes a RA field indicating a set of time domain resource units within a time domain scheduling window; then, in step S502, the user equipment performs the transmission operation of the TB, such as receiving or sending on the set of time domain resource units.

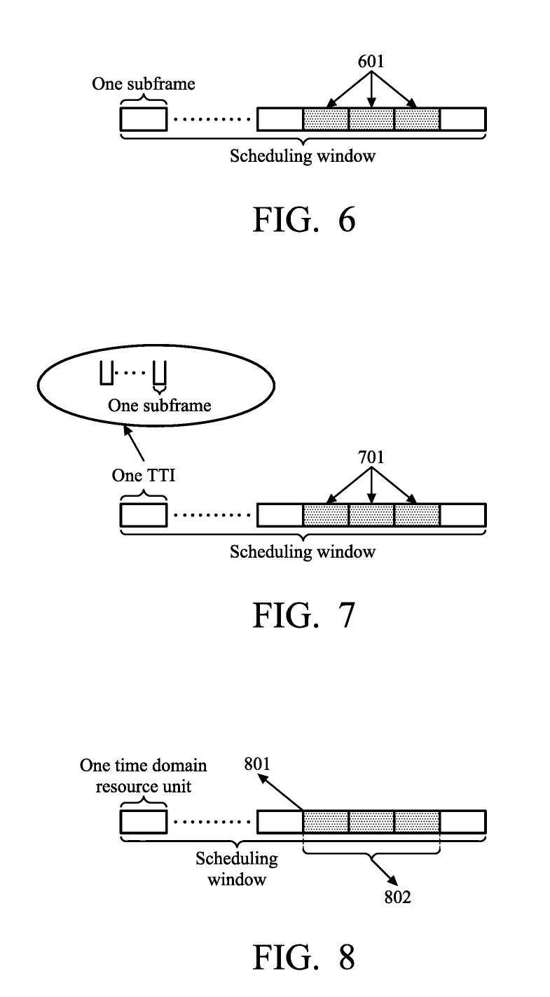

FIG. 6 is an exemplary diagram illustrating the time domain scheduling window according to an embodiment of the invention, wherein the time domain resource unit is a subframe. FIG. 7 is an exemplary diagram illustrating the time domain scheduling window according to an embodiment of the invention, wherein the time domain resource units are multiple subframes. The scheduling window at least contains multiple time domain resource units, and the time domain resource unit is the minimum granularity of the time domain resource. In one embodiment, as shown in FIG. 6, the time domain resource unit can be a subframe, and one or more subframes within the scheduling window that may be allocated for one TB. For example, a set of subframes are allocated to one TB 601 as shown in FIG. 6. In another embodiment, as shown in FIG. 7, the time domain resource unit can be a plurality of subframes, and the plurality of subframes may also be referred to as a minimum transmission time interval (TTI) or a minimum resource unit, or one or more TTIs within a scheduling window that may be allocated for a TB. For example, a set of TTIs are allocated to a TB 701 as shown in FIG. 7.

In another embodiment, the time domain resource unit can be a slot or a plurality of time slots, which may also be referred to as TTI or the minimum resource unit.

In one embodiment, the maximum number of time domain resource units that can be allocated for one TB is equal to the number of time domain resource units included in the scheduling window. In another embodiment, the maximum number of time domain resource units that can be allocated for one TB is less than the number of time domain resource units contained in the scheduling window.

In one embodiment, the number of time domain resource units included in the scheduling window can be a predefined fixed value. In another embodiment, the number of time domain resource units included in the scheduling window can be configurable values, and the values are indicated by the system broadcast information block (SIB) or UE-specific higher layer signaling (e.g., the RRC signaling). In another embodiment, the number of time-frequency resource units included in the scheduling window may be obtained by implicitly way, for example, the length of the scheduling window being equal to the period of the downlink control channel search space.

In one embodiment, the number of time domain resource units included in the uplink scheduling window and the number of time domain resource units included in the downlink scheduling window are the same, and when the time duration of the uplink time domain resource units and the time duration of the downlink time domain resource units are the same, the time durations held by the uplink and downlink scheduling windows are the same; otherwise, i.e., when they are not the same, then the time durations held by the uplink and downlink scheduling windows are the time durations held by the uplink and downlink scheduling window duration are different. In another embodiment, depending on a relationship of the time durations held by the uplink and downlink scheduling window, the number of time domain resource units included in the uplink scheduling window and the number of time domain resource units included in the downlink scheduling window may be different, while the time durations held by the uplink and downlink scheduling window may be the same or different.

In one embodiment, the duration of the scheduling window may be a predefined fixed value, while the duration of the time domain resource units may be a configurable value, and the number of time domain resource units included in the scheduling window may further be determined based on the duration of the predefined scheduling window and the duration of the allocated time domain resource unit. For example, the time units for the minimum scheduling resources with the number of carriers {1, 3, 6, 12} are {8, 4, 2, 1} milliseconds (or subframes), respectively, and for a fixed duration, for example 128 milliseconds (or subframes), the time domain resources that can be used for scheduling are {16, 32, 64, 128} units, respectively.

FIG. 8 is an exemplary diagram illustrating the continuous allocation of a set of time domain resource units within a scheduling window according to an embodiment of the invention. RA is required to indicate the position of the starting resource unit (e.g. 801 as shown in FIG. 8) and the number of continuous resource units allocated (e.g. 802 as shown in FIG. 8). The number of allocable continuous resource units and the position of the starting resource unit are related. For example, if the allocable starting resource unit is the first resource unit within the scheduling window, there are N_{RU}^{SW} possibility (i.e. 1˜N_{RU}^{SW}) of the number of allocable continuous resource units, in which N_{RU}^{SW} is the number of resource units within the scheduling window; if the initial resource unit allocated is the last resource unit within the scheduling window, the number of allocable continuous resource units can only be 1. Wherein the possibilities of all allocations add up to (N_{RU} ^{SW}/(N_{RU}^{SW}+1))/2 types, and thus |log₂(N_{RU}^{SW}/(N_{RU}^{SW}+1))/2| bits can be used to achieve the allocation of continuous resource units.

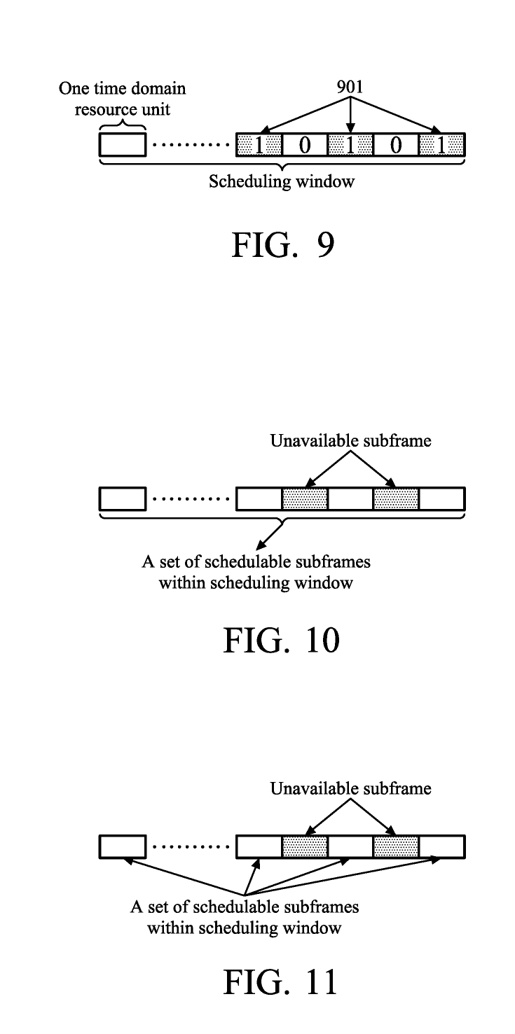

FIG. 9 is an exemplary diagram illustrating the discontinuous allocation of a set of time domain resource units within a scheduling window according to an embodiment of the invention. The RA may indicate the allocated resource units through a bitmap. The bitmap comprises a total of N_{Ru}^{SW} bits, each bit information corresponding to the scheduling information of a resource unit within the scheduling window, for example, bit of a value 1 indicates the resource unit being scheduled while bit of a value 0 indicates the resource unit not being scheduled. As shown in FIG. 9, a bitmap 901 (e.g., 0 . . . 10101) is used to indicate a discontinuous time domain resource allocation, where each bit information corresponds to scheduling information for a resource unit within the scheduling window.

### Embodiment 2

Based on the resource allocation within the scheduling window in the Embodiment 1, the Embodiment 2 provides a processing method for processing the unavailable subframe within the duration of the scheduling window. In particular, the method includes: the user equipment determines whether the each subframe within the duration of the scheduling window is an unavailable subframe; if so, the pre-defined processing method is utilized. The user equipment may determine whether or not a subframe is an unavailable subframe according to one higher layer signaling configuration, such as information pertaining to an available subframe or an unavailable subframe is pointed out through one bitmap signaling form using in SIB or RRC signaling. Bits of 1 and 0 denote the corresponding subframes are an available subframe and an unavailable subframe, respectively. In the TDD system, when scheduling a physical uplink data channel, the downlink subframe and special subframes that contain a very small number of uplink symbols are unavailable subframes; when scheduling a physical downlink data channel, the uplink subframe and special subframes that contain a very small number of downlink symbols are unavailable subframes.

The pre-defined processing method can be that a set of schedulable subframes within the scheduling window includes unavailable subframes. FIG. 10 is an exemplary diagram illustrating the time domain scheduling window including the unavailable subframes according to an embodiment of the invention. As shown in FIG. 10, the allocated subframe may be an unavailable frame. In that case, the actual number of available subframes may be smaller than the number of allocated subframes. Here, the duration of the scheduling window is fixed, while the number of available subframes within the scheduling window can be dynamically changed.

Based on FIG. 10, in one embodiment, the physical TBS being scheduled may be determined by the number of allocated subframes. That is, the number of subframes allocated determines the quantity of corresponding PRB or PRB pairs, thus deriving at corresponding TBS from the TBS-PRB mapping table. In another embodiment, the scheduled TBS may be determined by the actual number of available subframes. That is, the actual number of available subframes determines the number of PRBs, thus deriving at corresponding TBS from the TBS-PRB mapping table.

Based on FIG. 10, rate matching can be based on the number of subframes allocated. That is, the number of REs included in the unavailable subframe is also used in rate matching. After rate matching, data transmitted, which is supposed to be mapped to the unavailable subframe after rate matching, is directly discarded. In another embodiment, rate matching can be based on the actual number of available subframes. That is, the number of REs included in the unavailable subframe is not used in rate matching in order to avoid mapping data on the unavailable subframe.

In another embodiment, the predefined processing method can be that a set of schedulable subframes within the scheduling window excludes the unavailable subframes. FIG. 11 is an exemplary diagram illustrating the time domain scheduling window excluding the unavailable subframes according to an embodiment of the invention. As shown in FIG. 11, the actual number of available subframes equals the number of allocated subframes, while TBS and rate matching are based on the number subframes allocated. Data transmission should avoid unavailable subframes. That is, data transmission supposedly to be mapped to the unavailable subframes may be delayed to the next available subframe. Here, the duration held by the scheduling window is dynamically changed, which is dependent on whether or not unavailable subframes exist in the scheduling window and the number of unavailable subframes possibly in existence.

### Embodiment 3

In one embodiment, a method for determining the position of the starting subframe of the scheduling window is provided, which may be used in the above-described Embodiment 1 and/or Embodiment 2, wherein the method comprises: the user equipment receives a physical downlink control channel that allocates a set of time domain resource units based on a scheduling window; the user equipment further determines the position of the starting subframe of the scheduling window according to a predefined rule to determine the absolute position of a set of time domain resource units allocated in the scheduling window.

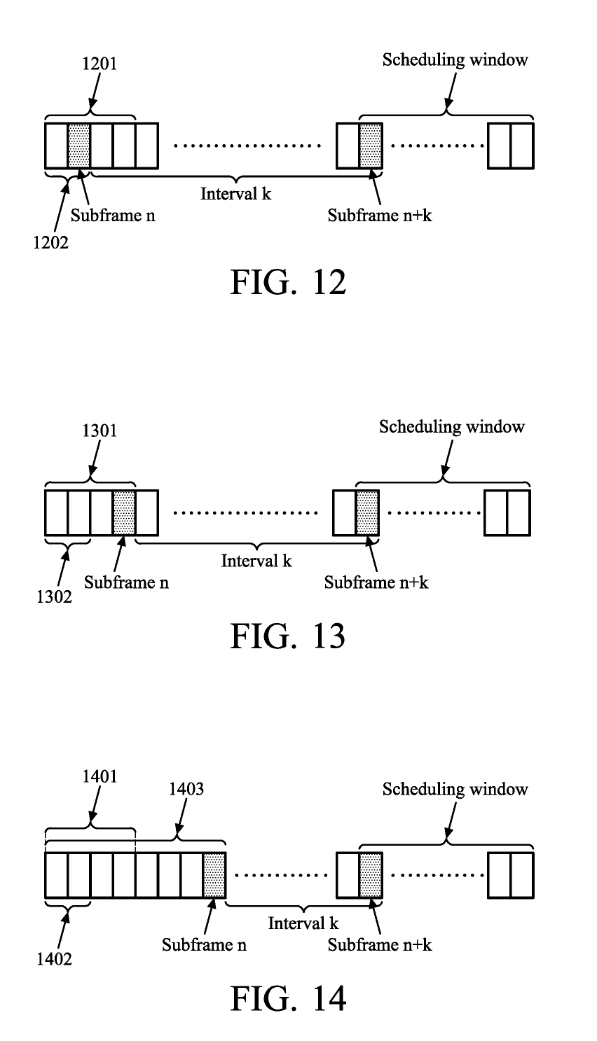

In one embodiment, the predefined rule is that the position of the starting subframe of the scheduling window is determined by the ending subframe of the Physical Downlink Control Channel (hereinafter also referred to as PDCCH) carrying the corresponding DCI. FIG. 12 is an exemplary diagram illustrating the starting position of the time domain scheduling window being determined by the end position of the corresponding physical downlink control channel according to an embodiment of the invention. As shown in FIG. 12, 1111 represents a subframe set occupied by the PDCCH search space, 1112 represents a subframe set occupied by the PDCCH carrying the corresponding DCI, and fixed interval is configured between a starting subframe of the scheduling window and an ending subframe of the corresponding PDCCH. For example, if the ending subframe of the PDCCH is the subframe n, the starting subframe of the scheduling window is the subframe n+k, where k is a fixed value.

In this embodiment, the PDCCH search space may across multiple subframes, and the PDCCH carrying the corresponding DCI occupies one or more subframes within the PDCCH search space. The starting subframe of the PDCCH may be the same as or different from the starting subframe of the PDCCH search space, and the ending subframe of the PDCCH may be the same as or different from the ending subframe of the PDCCH search space. For example, in FIG. 12, the starting subframe of the PDCCH is the same as the starting subframe of the PDCCH search space, while the ending subframe of the PDCCH is different from the ending subframe of the PDCCH search space.

For the scheduling of Physical Downlink Shared Channel (PDSCH) and Physical Uplink Shared Data Channel (hereinafter also referred to as PUSCH), the k value may vary. For example, in PDSCH scheduling, k=1; while in PUSCH scheduling, k=4. The interval between the ending subframe of PDCCH and the starting subframe of the scheduled physical data channel is determined by allocation information for the time domain resource unit within the scheduling window and k value. The time relationship between the two is dynamically changed.

In another embodiment, the pre-defined rule is that the position of the starting subframe of the scheduling window is determined by the ending subframe of the search space including the corresponding PDCCH. FIG. 13 is an exemplary diagram illustrating the starting position of the time domain scheduling window being determined by the end position of the search space including the corresponding physical downlink control channel according to an embodiment of the present invention. As shown in FIG. 13, 1301 represents a subframe set occupied by the PDCCH search space, and 1302 represents a subframe set occupied by the PDCCH carrying corresponding DCI. There is a fixed interval between the starting subframe of the scheduling window and the ending subframe of the corresponding PDCCH search space. For example, given the ending subframe of the PDCCH search space is subframe n, the starting subframe of the scheduling window is subframe n+k, with k as a fixed integer number. The interval between the ending subframe of PDCCH and the starting subframe of the scheduled physical data channel is jointly determined by the position of PDCCH in the PDCCH search space, the allocation information for the time domain resource units within the scheduling window and k value. The time relationship between the two may be dynamically changed.

The above method may also be applied to directly indicate the starting position of the scheduling resource block for the uplink or downlink sending/transmission. For example, by using a field in the DCI to indicate the interval k between the ending subframe of the PDCCH (or the ending subframe of the PDCCH search space or the ending subframe of the PDCCH downlink control area) and the starting position of the scheduling resource block, where k can be a subframe or the number of subframes in a TTI.

In another embodiment, the interval k may also be defined compared with a starting subframe with a PDCCH, a PDCCH search space, or a PDCCH downlink control area. The interval may be pre-defined, or indicated by DCI or higher layer signaling.

More particularly, for the starting position of Msg3, since the uplink resource for Msg3 transmission is indicated in the RAR, the starting transmission position of Msg3 can be obtained in a similar manner. For example, the UE determines the starting subframe position for transmitting the uplink resource of Msg3 or the position of starting scheduling window by an interval k and the ending subframe (or starting subframe) position of the PDSCH for transmitting the RAR. The above-mentioned interval k is a scheduling delay between the start transmission position (starting subframe position) of the message 3 (Msg3) and the ending subframe of the corresponding PDSCH transmitting the RAR. The interval may be pre-defined, or be indicated in the MAC CE in the RAR. Similarly, k may indicate a metric in units of subframes or in units of the number of subframes in the TTI.

In yet another embodiment, the predefined rule can be the starting subframe position of the scheduling window is determined by the ending subframe of the downlink control area including the corresponding PDCCH. FIG. 14 is an exemplary diagram illustrating the starting position of the time domain scheduling window being determined by the end position of the control area including the corresponding physical downlink control channel according to an embodiment of the invention. As shown in FIG. 14, 1401 represents a subframe set occupied by the PDCCH search space, 1402 represents a subframe set occupied by the PDCCH carrying the corresponding DCI, and 1403 represents a subframe set occupied by a physical downlink control area. There is a fixed interval between the starting subframe of the scheduling window and the ending subframe of the corresponding downlink control area, for example, if the ending subframe of the downlink control area is subframe n, then the starting subframe of the scheduling window is subframe n+k, where k is a fixed value. The interval between the ending subframe of the PDCCH and the starting subframe of the scheduled physical data channel is joinly determined by the position of the PDCCH in the downlink control area, the allocation information for the time domain resource units within the scheduling window and the k value, and the time relationship between the two may be dynamically changed.

Here, the base station allocates a part of the continuous time domain resources to the downlink control area and indicates the size and position of the downlink control area in the SIB. The PDCCH search space allocated by UE-specific higher layer signaling (e.g., RRC signaling) must be present in the downlink control area, wherein the starting subframe of the PDCCH search space may be the same as or different from the starting subframe of the downlink control area, and the ending subframe of the PDCCH search space and the ending frame of the downlink control area may be the same or different.

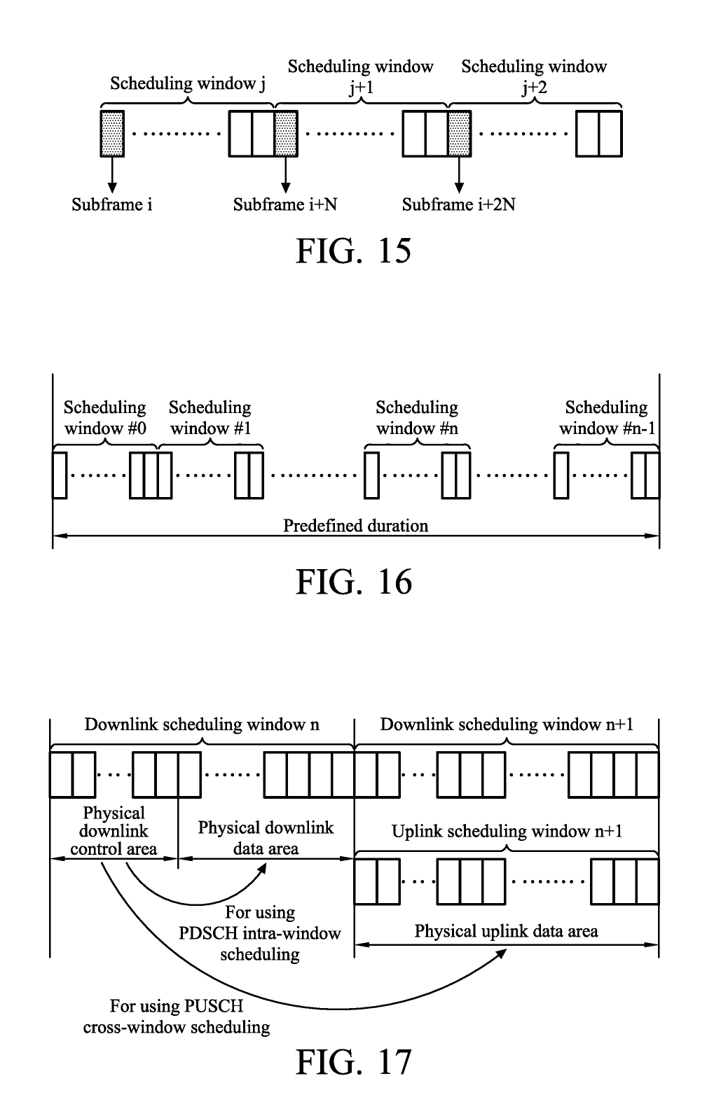

In one embodiment, the predefined rule can be that the starting subframe position of the scheduling window is determined by the subframe number, the frame number, and the number of subframes included in the scheduling window. FIG. 15 is an exemplary diagram illustrating the starting position of the time domain scheduling window being determined by the subframe number, the frame number, and the number of subframes included in the scheduling window according to an embodiment of the invention. As shown in FIG. 15, if the subframe i is the starting subframe of the scheduling window j, the starting subframe of the scheduling window j+1 is the subframe i+N, the starting frame of the scheduling window j+2 is the subframe i+2N, where N is the number of subframes included in the scheduling window. The starting subframes of the subsequent scheduling window can be set so forth. That is, multiple scheduling windows are continuous in time, and the continuous duration of each scheduling window is a fixed value.

In the current LTE system, one wireless frame includes 10 subframes, and the system frame number (SFN) is numbered from 0 to 1023. According to FIG. 15, the starting subframe position of the first scheduling window may be predefined, for example, the first subframe in the wireless frame#0. The absolute number of each subframe as 10n+m could be obtained based on the subframe number #m (m=0-9) and the wireless frame number #n (n=0˜1023) , and then the subframe of (10n+m)% N=0 is the starting subframe of a scheduling window, where N is the number of subframes included in the scheduling window.

According to FIG. 15, in one embodiment, a predefined time period is divided into a plurality of scheduling windows, and the set of the plurality of scheduling windows may be referred to as “scheduling frames”, “Super-Window” or the like, wherein the plurality of scheduling windows are numbered. FIG. 16 is an exemplary diagram illustrating the numbering of a plurality of scheduling windows within a given time period from #1 to #(N−1) and the initialization of the scrambling sequence generator using the number for the scheduling window according to an embodiment of the invention. As shown in FIG. 16, the number of the scheduling window may be involved in the initialization of the scrambling sequence generator used for physical data channel transmission, such as cᵢₙᵢₜ=n_{RNTI}·2¹⁴+n_{sw}·2⁹+N_{ID}^{cell}, where n_{sw} is the number of the scheduling window, n_{RNTI} is the C-RNTI value of the UE, N_{ID}^{cell} is the ID number of the cell to which the UE belongs.

For example, the above-mentioned predefined continuous duration is 60 ms, that is, including 60 subframes (one subframe duration is 1 ms), and each scheduling window includes six subframes. Then, there are 10 scheduling windows included in the 60 ms continuous duration, and the number of the scheduling window is 0˜9. In another embodiment, the number of the scheduling window may also be used to determine other parameters used for physical data channel transmission, such as initialization of the reference signal generator and so on.

In one embodiment, each downlink scheduling window includes a physical downlink control area and a physical downlink data area, wherein the physical downlink control channel and the set of scheduled time domain resource units belong to the same scheduling window or different scheduling windows. FIG. 17 is an exemplary diagram illustrating a downlink scheduling window including a physical downlink control area and a physical downlink data area, and performing a same-window scheduling for downlink and performing a cross-window scheduling for uplink according to an embodiment of the invention. As shown in the upper part of FIG. 17, for the use of PDSCH same-window scheduling, the physical downlink control area in the downlink scheduling window n is a set of time domain resource units in the downlink data area of the scheduling window allocated in the PDSCH, i.e., the same-window scheduling; As shown in the lower part of FIG. 17, for the use of PUSCH cross-window scheduling, the physical downlink control area in the downlink scheduling window n is a set of time domain resource units in the uplink data area of the uplink scheduling window n+1 allocated in the PUSCH, i.e., the cross-window scheduling. In another embodiment, cross-window scheduling may also be used for PDSCH allocation.

According to FIG. 17, in one embodiment, the physical downlink control area and the physical downlink data area in the downlink scheduling window are composed of a plurality of consecutive time domain resource units, and the physical downlink control area starts from the starting position of the scheduling window. The time domain resource units out of the physical downlink control area belong to the physical downlink data area. The number of time domain resource units included in the physical downlink control area is a configurable value, such as configured in the SIB or configured by a UE-specific higher layer signaling.

According to FIG. 17, in one embodiment, the UE is configured with a physical downlink control area and a PDCCH search space, wherein the former of which is indicated by the SIB while the latter is configured by a UE-specific higher layer signaling. The time domain resource unit occupied by the latter must exist in the former, i.e., the number of time domain resource units included in the latter should be less than or equal to the number of time domain resource units included in the former. In another embodiment, the UE only configures the PDCCH search space, which may be configured by SIB or UE specific higher layer signaling, where the PDCCH search space is the downlink control area as shown in FIG. 16.

According to FIG. 17, in one embodiment, the time domain resource units allocated for the PDSCH can only belong to the physical downlink data area, i.e., the maximum number of time domain resource units that the PDSCH can allocate can be less than or equal to the number of the time domain resource units included in the physical downlink data area. In one embodiment, the size of the RA field for scheduling the PDSCH is determined by the number of time domain resource units included in the physical downlink data area, and the size of the RA field for the downlink resource allocation is different from the size of the RA field for the uplink resource allocation when the number of the downlink time domain resource units included in the physical downlink data area is different from the number of the uplink time domain resource units included in the physical uplink data area. In another embodiment, the size of the RA field for the PDSCH may still be determined by the number of time domain resource units included in the downlink scheduling window, and the base station avoids allocating the time domain resource units within the physical downlink control area to the PDSCH.

According to FIG. 17, in one embodiment, the time domain resource units allocated for the PDSCH may be present in the physical downlink control area, i.e., the maximum number of time domain resource units that the PDSCH can allocate may be greater than the number of time domain resource units included in the physical downlink data area. If the time domain resource unit reserved for the physical downlink control area is not used by the PDCCH in the actual transmission, it can be scheduled to the PDSCH. Here, the size of the RA field for downlink resource allocation is determined by the number of time domain resource units included in the downlink scheduling window, and the base station may allocate the time domain resource unit in the physical downlink control area to the PDSCH and the allocated time domain resource unit are located after the ending subframe of the corresponding PDCCH.

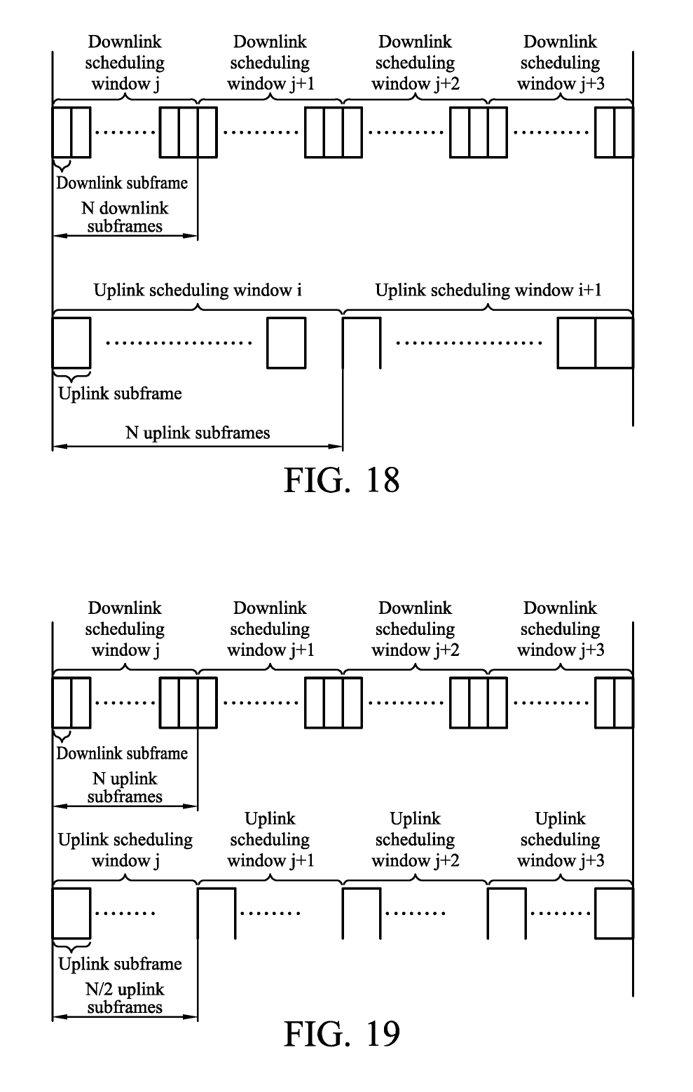

FIG. 18 is an exemplary diagram illustrating the situation that the number of subframes included in the downlink scheduling window and the number of subframes included in the uplink scheduling window are inconsistent, but the duration of the uplink scheduling window and the down link scheduling window is the same according to an embodiment of the invention. For example, the duration of the downlink subframe is lms, and the duration of the uplink subframe is twice that of the downlink subframe (i.e., 2 ms), wherein the downlink scheduling window includes N downlink subframes, while the uplink scheduling window includes N/2 uplink subframes. Since the uplink scheduling window and the downlink scheduling window have the same duration the numbers of the uplink scheduling window and the down link scheduling window correspond to each other. Each downlink scheduling window includes a physical downlink control area. The physical downlink control area can allocate the uplink time domain resources of one uplink scheduling window. For example, the physical downlink control area of the downlink scheduling window can allocate the time domain resources within the uplink scheduling window n+1.

FIG. 19 is an exemplary diagram illustrating the situation that the duration of the downlink scheduling window is different from the duration of the uplink scheduling window while the number of subframes in the downlink scheduling window is the same as that in the uplink scheduling window according to an embodiment of the invention. For example, the duration of the downlink subframe is 1 ms, and the duration of the uplink subframe is twice that of the downlink subframe (i.e. 2 ms). Since the number of subframes is the same for both the uplink and downlink scheduling windows, the duration of the uplink scheduling window is twice that of the downlink scheduling window. In this case, the number of downlink scheduling windows within a given time will be twice that of the uplink scheduling window. In one embodiment, the time domain resources of the uplink scheduling window can only be allocated by the physical downlink control area of downlink scheduling window 2n. In another embodiment, the time domain resources of the uplink scheduling window can only be allocated by the physical downlink control area within the downlink scheduling window 2n+1. In yet another embodiment, the time domain resources of the uplink scheduling window can be allocated by the physical downlink control area of the downlink scheduling window 2n or 2n+1.

In another embodiment, a length of the uplink scheduling window is related to the TTI length corresponding to the different numbers of subcarriers allocated. For example, the time units of the minimum scheduling resource for the number of carriers {1, 3, 6, 12} are {8, 4, 2, 1} milliseconds (or subframes), respectively, and the lengths of the corresponding uplink scheduling windows are {128, 64, 32, 16} milliseconds (or subframes), respectively. In this case, the number of resource blocks that can be indicated for the different number of subcarriers or different subcarrier intervals in one scheduling window are the same. For example, for 3.75 kHz and 15 kHz with a same number of subcarriers of 1, the length of the 3.75 kHz uplink scheduling window can be 4 times that of 15 kHz.

### Embodiment 4

Based on the above-described Embodiment 1, Embodiment 2 and Embodiment 3, the present invention provides a method of designing content of RA field in a DCI, wherein the method comprises: the RA field of the DCI includes at least one or more of the following information: the positions of time domain resource units allocated within a time domain modulation window; the number of time domain resource units allocated within a frequency domain modulation window; the positions of frequency domain resource units allocated within a frequency domain scheduling bandwidth; and the number of frequency domain resource units allocated within a frequency domain modulation bandwidth. The time domain resource unit is the minimum scheduling granularity of the time domain resource, and the frequency domain resource unit is the minimum scheduling granularity of the frequency domain resource.

In one embodiment, a set of frequency domain resource units allocated within a frequency domain scheduling bandwidth are continuous. In another embodiment, a set of frequency domain resource units allocated within the frequency domain scheduling bandwidth are discontinuous. In one embodiment, a set of time domain resource units allocated within a time domain scheduling window are continuous. In another embodiment, a set of time domain resource units allocated within a time domain scheduling window are discontinuous. Examples of the above-mentioned time-frequency domain allocation may have various combinations.

In one embodiment, the information may be independently encoded when constructing a RA field, i.e., the RA field includes two independent subfields, one subfield indicating time domain scheduling information and the other subfield indicating frequency domain scheduling information. The aforementioned information can also be combined when constructing the RA field. That is, the RA field includes only one subfield, which comprehensively indicates all the possibilities of the frequency domain and the time domain modulation information.

In one embodiment, the time domain resource unit can be a subframe. In another embodiment, the time domain resource units can be a plurality of subframes. In one embodiment, the time domain resource unit described above includes different number of subframes in the uplink and downlink, e.g., the downlink time domain resource unit is a subframe, while the uplink time domain resource unit includes 6, 8, 10 or 12 subframes. In one embodiment, the duration of the uplink subframe and the downlink subframe are different, such as the downlink subframe is lms and the uplink subframe is 2 ms or 5 ms.

In one embodiment, the frequency domain resource unit can be a plurality of subcarriers, such as the frequency domain resource unit is a PRB including 12 subcarriers. In one embodiment, the frequency domain resource unit is different in the number of subcarriers included in the uplink and downlink, for example, the downlink frequency domain resource unit is 12 subcarriers and the uplink frequency domain resource unit is one subcarrier. In one embodiment, the downlink subcarrier spacing is different from the uplink subcarrier spacing, e.g., the downlink subcarrier spacing is 15 kHz and the uplink subcarrier spacing is 3.75 kHz.

In one embodiment, frequency domain resource unit allocated within a frequency domain scheduling bandwidth is fixed to a frequency domain resource unit, wherein the position of the frequency domain resource unit within the frequency domain scheduling bandwidth may be indicated in the DCI, or configured via a higher layer signaling. In another embodiment, the number of maximum frequency domain resource unit contained within the scheduling bandwidth is fixedly allocated, i.e. the number and position of the frequency domain resource units allocated within the frequency domain scheduling bandwidth are fixed and need not be indicated in the DCI.

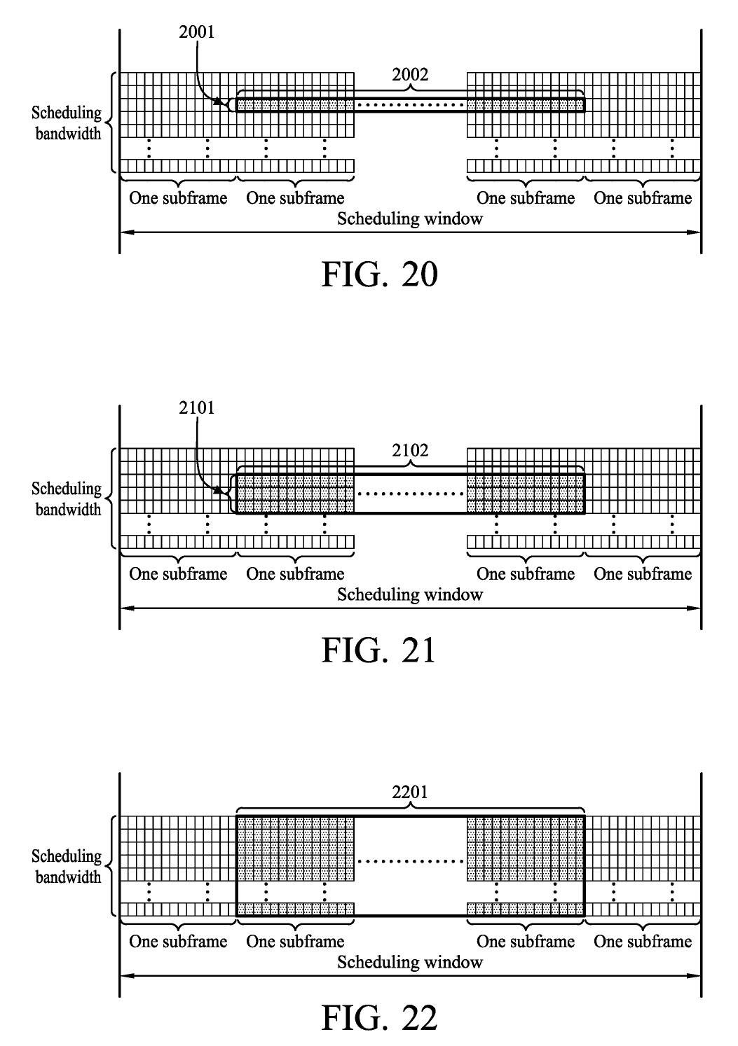

FIG. 20 is an exemplary diagram illustrating a resource allocation method based on a single-tone transmission mode and a scheduling window according to an embodiment of the invention, that is, the user equipment can only allocate one subcarrier in the frequency domain. The RA field includes the following information: the locations of the allocated subcarriers within the scheduling bandwidth (11101 as shown in FIG. 20); and the number and position of the time domain resource units allocated in the scheduling window (2002 as shown in FIG. 20). In another embodiment, the position of the allocated subcarriers within the scheduling bandwidth is not indicated in the DCI, but is configured by a UE-specific higher layer signaling. In another embodiment, the scheduling bandwidth is less than the system bandwidth or RF bandwidth. The relative position of the scheduling bandwidth in the system bandwidth or RF bandwidth can be configured through higher layer signaling, such as RRC signaling. Further, the DCI indicates the position of the specific frequency domain resources, such as a carrier, in the scheduling bandwidth.

FIG. 21 is an exemplary diagram illustrating a resource allocation method based on a multi-tone transmission mode and a scheduling window according to an embodiment of the invention, in which a user equipment can allocate a set of subcarriers within a frequency domain scheduling bandwidth, and the RA field includes the following information: the number and position of the frequency domain resource units allocated in the frequency domain scheduling window (2101 as shown in FIG. 21); and the number and position of the time domain resource units allocated in the time domain scheduling window (2102 as shown in FIG. 21). For example, the scheduling bandwidth is 180 kHz, the subcarrier spacing is 15 kHz, and the scheduling bandwidth includes 12 subcarrier intervals. In one embodiment, the user equipment may be allocated with 1 to 12 subcarriers. In another embodiment, the user equipment may be allocated with 1, 3, 6, and 12 subcarriers. In yet another embodiment, the user equipment may be allocated with 6 and 12 subcarriers. In yet another embodiment, the user equipment may be allocated with 1, 2, 4, 8, and 12 subcarriers.

FIG. 22 is an exemplary diagram illustrating a resource allocation method based on a full-tone transmission mode and a scheduling window according to an embodiment of the invention, i.e., the user equipment is always allocated with all subcarriers within the scheduling bandwidth. The RA field includes the following information: the number and the position of the time domain resources allocated in the time domain scheduling window (2201 as shown in FIG. 22).

In order to reduce the number of times the PDCCH blind detecting performed by the UE, the probability of the number of bits of the PDCCH information is as small as possible, such as one. If the number of carriers in the frequency domain needs to be indicated in the DCI, the DCI size is the same for scheduling the different number of frequency domain resource carriers so that the DCI size for PUSCH and PDSCH is the same. As the SINR of the receiver can be improved by occupying a small bandwidth to perform the uplink transmission power spectral density boosting (PSD boosting) enhancement, the channel estimation performance can be improved, thereby enhancing the user's data rate. On the other hand, bandwidths saved can be allocated to other UEs. For example, the uplink may use a 3.75 kHz single carrier or a 15 kHz single carrier, and a different number of subcarriers, e.g., 3, 6, and 12 carriers. For a given system bandwidth, for example, 180 kHz, different numbers of subcarriers may correspond to different numbers of resource blocks in the frequency domain. For example, if the frequency domain resources can be arbitrarily allocated, {1, 3, 6, 12} carriers have {12, 4, 2, 1} allocatable resources in the frequency domain, respectively. Specifically, in one embodiment, 12 carriers can be divided into four blocks, each containing three carriers. In another embodiment, if the resource is allocated to any position in the frequency domain, there could be {12, 9, 6, 1} allocatable resource locations corresponding in the frequency domain in {1, 3, 6, 12} thereto in the frequency domain. That is, the size of the RA field used to indicate the frequency domain resource position is different from the number of different carriers. For example, 4 bits, 2 bits, 1 bit, or no bits are required to indicate {12, 4, 2, 1} resources corresponding to {1, 3, 6, 12}, respectively. On the other hand, in order to provide a considerable bit rate, reducing the amount of resources occupied in the frequency domain will increase the time required for the time domain transmission, that is, TTI length of different number of carriers is different. In one embodiment, the TTI lengths corresponding to {1, 3, 6, 12} carriers are {8, 4, 2, 1} milliseconds, respectively. Then, the number of information bits required at the same time resource may be different.

In order to indicate an uplink resource, the position occupied by the frequency domain and the position occupied by the time domain can be indicated. Considering that SC-FDMA is single carrier transmission, only the number of subcarriers and the frequency domain location needs to be indicated in the frequency domain. Also in order to save UE power consumption, indication for time domain resources can be simplified as the starting position of the time domain and the number of subframes in time domain. Several of the above fields may be indicated separately or be jointly coded and indicated.

In one embodiment, the number of subcarriers is indicated by 2 bits, the position of the frequency domain is indicated by 2 bits for one or three subcarriers, wherein for a single carrier transmission, a higher layer signaling is used to indicate a scheduling bandwidth, such as including eight subcarriers, and then 3 bits in the DCI are further used to indicate which of the eight subcarriers is. In one embodiment, the starting position of a scheduling bandwidth and the number of carriers contained can be directly given by the higher layer signaling. In another embodiment, the higher layer signaling indicates one of the scheduling bandwidths in advance. Alternatively, the higher layer signaling may directly provide the subcarrier serial number corresponding to the scheduling bandwidth, where the subcarrier serial number may be continuous or discontinuous. For 6 carriers, the position of the frequency domain is indicated by one bit. For 12 subcarriers, no additional indication of the frequency domain position is required. For different carrier intervals, indications can use the higher layer signaling. In another embodiment, an additional information bit indicates a different carrier interval, such as 3.75 kHz or 15 kHz.

In another embodiment, the number of frequency domain carriers, the carrier position, and the subcarrier spacing are jointly encoded, as shown in Table 1. In another embodiment, the frequency domain carrier position may be replaced by a frequency domain carrier starting position, or a frequency domain resource number. In Table 1, k can be indicated by higher layer signaling. In another embodiment, a scheduling bandwidth may be indicated by higher layer signaling, and the carrier position in the scheduling bandwidth may further be indicated by the DCI, where k=0.

For the scheduling of Msg3, the scheduling information of Msg3 can be given in the RAR. The scheduling in the RAR, for example, can be given by the system information, or by implicit ways or calculated based on the RAR information (such as transmission location, control information calling the RAR), or PRACH information. The above-mentioned joint encoding can be applied to the indication of Msg3.

Please refer to Table 1: where a set of subcarriers can be defined as a time-frequency resource block (PRB), such as defining subcarriers #0-#5 as PRB #0 with 6 carriers, or defining subcarriers #6-#11 as PRB #1 with 6 carriers. Similarly, four PRBs can be defined for three carriers, 12 PRBs can be defined for a single carrier of 15 kHz, and 48 PRBs can be defined for a single carrier of 3.75 kHz.

TABLE 1
Joint coding of the number of subcarriers in the frequency domain, the
subcarrier spacing and the subcarrier position.

| Serial | The number of | Frequency domain | |
|---|---|---|---|
| number | carriers | subcarrier position | Subcarrier spacing |
| 0 | 12 | #0-#11 | 15 kHz |
| 1 | 6 | | |
| 2 | 6 | #6-#11 | |
| 3 | 3 | | |
| 4 | 3 | | |
| 5 | 3 | | |
| 6 | 3 | #9-#11 | |
| 7 | 1 | #k | |
| 8 | 1 | #k + 1 | |
| 9 | 1 | #k + 2 | |
| 10 | 1 | #k + 3 | |
| 11 | 1 | #k | 3.75 kHz |
| 12 | 1 | #k + 1 | |
| 13 | 1 | #k + 2 | |
| 14 | 1 | #k + 3 | |
| 15 | Reserved | | |

Correspondingly, in the indication of the time domain resource, different numbers of bits are required for different TTI lengths. Further, in order to more flexibly indicate the starting position of the time domain, for example, if a scheduling window is of 128 milliseconds, or a transport block can allocate up to 16 TTIs (or the length of the minimum scheduling resource), or a DCI is responsible for allocating resources of 128 subframes, for a single carrier transmission, the TTI length is 8 milliseconds (or subframes) and thus 4 bits are required for indication, while for the scheduling of 3 subcarriers, the TTI length is 4 milliseconds (or subframes) and 5 bits are required for indication. For the scheduling of 6 subcarriers or the scheduling of 12 subcarriers, 6 bits or 7 bits are required for indication, respectively.

In one embodiment, the UE successfully decodes a PDCCH to obtain a DCI that contains at least a field for indicating the number of subcarriers and a field indicating the starting position of the frequency domain or the time domain. The UE first obtains the number of subcarriers of the scheduling resource block by the field indicating the number of subcarriers, determines the number of bits of other fields based on the number of subcarriers and further analyzes the resource block positions in the frequency domain and time domain according to the number of bits of other fields.

Considering both the frequency domain and time domain indications, the total number of information bits required for indicating any number of subcarriers is the same for scheduling windows with 12 subcarrier bandwidths and 120 milliseconds (or subframes), as shown in Table 2.

TABLE 2
shows the number of bits for indicating the
frequency domain position and the time
domain starting position of different numbers of carriers

| | 1 | 3 | 6 | 12 |
|---|---|---|---|---|
| Field | subcarrier | subcarriers | subcarriers | subcarriers |
| Frequency | 3 bits | 2 bits | 1 bit | — |
| domain | | | | |
| position | | | | |
| Time domain | 4 bits | 5 bits | 6 bits | 7 bits |
| starting | | | | |
| position | | | | |
| Total number | 7 bits | 7 bits | 7 bits | 7 bits |

Further, it is necessary to indicate the number of resource blocks occupied in time domain. Considering the same size of the maximum transport block that the user can transmit, the maximum number of time domain resource blocks is the same, such as up to 16 resource blocks, and 4 bits of information are required for indication. As shown in Table 3, for different numbers of subcarriers, the total number of information bits used to indicate the scheduling information time-frequency resource position is the same.

TABLE 3
Number of information bits for scheduling
information with different numbers
of carriers

| | 1 | 3 | 6 | 12 |
|---|---|---|---|---|
| Field | subcarrier | subcarriers | subcarriers | subcarriers |
| The number | 2 bits | | | |
| of subcarriers | | | | |
| Frequency | 3 bits | 2 bits | 1 bit | — |
| domain position | | | | |
| Time domain | 4 bits | 5 bits | 6 bits | 7 bits |
| starting position | | | | |
| The number | 4 bits | | | |
| of resource | | | | |
| blocks | | | | |
| Total number | 13 bits | 13 bits | 13 bits | 13 bits |

In another embodiment, a plurality of time domain scheduling windows may be defined, a field indicating the number of subcarriers in a DCI, a field of frequency domain position, a field of scheduling window serial number, and a field of time domain resource position within the scheduling window, as shown in FIG. 4. The size of the DCI is the same for the different numbers of subcarriers.

TABLE 4
Number of information bits for scheduling information with
different numbers of carriers different carriers

| | 1 | 3 | 6 | 12 |
|---|---|---|---|---|
| Field | subcarrier | subcarriers | subcarriers | subcarriers |
| The number of | 2 bits | | | |
| subcarriers | | | | |
| Frequency domain | 3 bits | 2 bits | 1 bit | — |
| position | | | | |
| Scheduling window | — | 1 bit | 2 bits | 3 bits |
| serial number | | | | |
| Time domain resource | 8 bits | | | |
| position within | | | | |
| scheduling window | | | | |
| Total number | 13 bits | 13 bits | 13 bits | 13 bits |

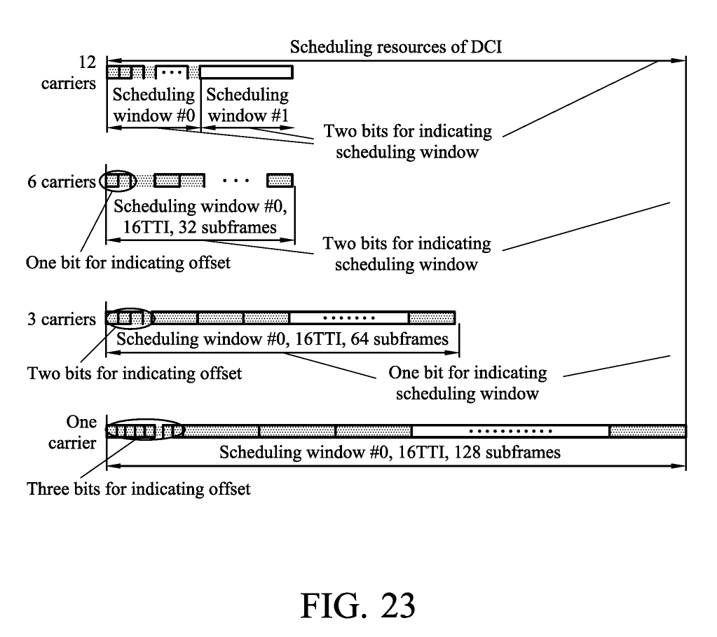

FIG. 23 is an exemplary diagram illustrating the resources of time domain are jointly indicated by the position of the scheduling resource and an offset according to an embodiment of the invention. For example, in a scheduling scheme that can schedule up to 16 time domain resources, the type 0 (type 0) is scheduled via the 3GPP uplink, and 8 bits information are required to indicate the positions occupied by the allocated uplink resources in the 16 time domain resources. In another embodiment, 4 bits information may be used to indicate which one of the 16 resources and 4 bits information may be used to indicate that the number of time domain resources being occupied. A 3-bit offset indicates the starting position of the 16 time domain resources. The offset can also be understood as the position of the PUSCH relative to the PDCCH or the relative position of the scheduling window and the PDCCH. In FIG. 23, the scheduling resources of the DCI may be, for example, 128 subframes, but the invention is not limited thereto. As shown in FIG. 23, for time domain resources of a given number of subcarriers, the number of scheduling windows may be different for different numbers of subcarriers. For example, in 128 subframes, there may be 8 scheduling windows, each of which containing 12 subcarriers, or be 4 scheduling windows, each of which containing 6 subcarriers, or include 3 scheduling windows, in which each of two of the three scheduling windows contains three carriers, and the remaining one of the three scheduling windows contains a single carrier. As the TTI length for different number of subcarriers is also different, in order to make an uplink transmission start at any one of the subframes, the 6, 3, and 1 carrier needs 1 bit, 2 bits, and 3 bits, respectively, to indicate an offset. Considering both the indication of the offset and the scheduling window, the number of information bits required for the scheduling of the different number of subcarriers is the same. As shown in FIG. 23, 3 bits are required.

The UE first acquires the number of subcarriers, and analyzes the time domain position of the scheduling window based on the number of subcarriers. In one embodiment, the time domain position of the scheduling window may be indicated by the subframe offset and the scheduling window serial number. In another embodiment, the time domain position of the scheduling window may be indicated directly based on the number of subcarriers and the length of TTI. For example, for 12 carriers, the TTI length is 1 millisecond (or subframe), and thus the basic unit for indicating the number of information bits in the scheduling window is 1 millisecond (or subframe), while for 6, 3, and 1 subcarriers, the TTI lengths corresponding thereto are 2, 4 and 8 milliseconds (or subframes), respectively, and thus the basic units for indicating the number of information bits in the scheduling window are 2, 4, and 8 milliseconds (or subframes), respectively. In another embodiment, for 12, 6, 3, and 1 subcarriers, the corresponding TTI lengths are 1, 2, 4 and 8 times those of the length of the scheduling window. In other words, if the scheduling window is determined according to the PDCCH position, the information bit is used to directly indicate the serial number of the scheduling window. With the same size of information bits, the indicated starting position of the scheduling window can be differently. Such a scheduling may cause a blocking problem (where a resource can't be allocated) or a PDCCH indicating a different length of frequency domain resources. For example, a DCI can schedule 16 milliseconds (or subframes) of time domain resources for 12 subcarriers, and schedule 128 milliseconds (or subframes) of time domain resources for one subcarrier. Table 5 gives a summary of the number of information bits based on the scheduling window serial number, the subframe offset, and the time domain resource position within the window.

TABLE 5
Number of information bits for scheduling
information with different numbers of carriers

| | 1 | 3 | 6 | 12 |
|---|---|---|---|---|
| Field | subcarrier | subcarriers | subcarriers | subcarriers |
| Frequency domain | 4 bits | | | |
| position (Note 1) | | | | |
| Scheduling | — | 1 bit | 2 bits | 3 bits |
| window serial | | | | |
| number (Note 2) | | | | |
| Subframe offset | 3 bits | 2 bits | 1 bit | — |
| (Note 2) | | | | |
| Time domain | 8 bits | | | |
| position within | Note: Here 4 bits for the starting position | | | |
| scheduling window | and 4 bits for the number of resource | | | |
| (starting position | blocks; or via jointly coding | | | |
| and the number of | | | | |
| resource blocks) | | | | |
| Total Number | 15 bits | 15 bits | 15 bits | 15 bits |

(Note 1):
In Table 5, the frequency domain position may be expressed by way of the joint coding as shown in Table 1, or by way of separately indicating the number of subcarriers (e.g., 2 bits) and the frequency domain position (e.g., 2 bits).
(Note 2):
The subframe offset and the scheduling window serial number are used to indicate the time domain position of the scheduling window, either by way of a joint encoding or by way of direct indication of absolute value.

According to the aforementioned embodiment, the UE obtains a method of scheduling resources after obtaining the uplink scheduling information, the method comprising: obtaining first frequency domain scheduling information by analyzing a field in the DCI; determining the number of bits in a second field of the DCI based on the first frequency domain scheduling information and analyzing the second field to obtain time domain scheduling information, wherein the frequency domain scheduling information is the number of subcarriers. In one embodiment, the time domain scheduling information is a scheduling window starting position, or a scheduling window serial number. In another embodiment, the time domain scheduling information is the time domain starting position of the scheduled resources.

In the first implementation, the analyzing step may comprise one or more of the following steps: analyzing the field indicating the number of subcarriers to obtain the number of subcarriers in the uplink scheduling information; obtaining the number of bits from the field indicating the frequency domain scheduling based on the number of subcarriers and analyzing the field indicating the frequency domain scheduling to obtain frequency domain scheduling information; obtaining the number of bits from the field indicating the starting position of the time domain resources based on the number of subcarriers and analyzing the field indicating the starting position of the time domain resources to obtain the starting position of the time domain resources; and obtaining the number of time domain resources according to the field indicating the number of time domain resources.

In the second implementation, the step of the UE analyzing the uplink scheduling information comprises one or more of the following steps: analyzing the field indicating the number of subcarriers to obtain the number of subcarriers in the uplink scheduling information; obtaining the number of bits from the field indicating the frequency domain scheduling based on the number of subcarriers and analyzing the field indicating the frequency domain scheduling to obtain frequency domain scheduling information; obtaining the number of bits from the field indicating the position of the scheduling window based on the number of subcarriers and analyzing the field indicating the position of the scheduling window to obtain the position of the scheduling window; and analyzing the field indicating the position of time domain resource within the scheduling window to obtain the position of time domain resource within the scheduling window and obtaining the position of time domain resource for uplink transmission according to the position of the scheduling window.

In a third implementation, the step of the UE analyzing the uplink scheduling information includes one or more of the following steps: analyzing the field indicating the position of frequency domain resources to obtain the position of frequency domain resource and the number of subcarriers; obtaining the field indicating the position of the scheduling window based on the number of subcarriers and analyzing the field indicating the position of the scheduling window to obtain the position of the scheduling window; analyzing the field indicating the subcarrier offset to obtain the subcarrier offset; analyzing the field indicating the position of time domain resource within the scheduling window to obtain the position of time domain resource within the scheduling window; and obtaining the position of time domain resource for uplink transmission according to the position of the scheduling window and the subcarrier offset.

In a fourth implementation, the step of the UE analyzing the uplink scheduling information includes one or more of the following steps: analyzing the field indicating the position of frequency domain resources to obtain the position of frequency domain resource and the number of subcarriers; analyzing the field indicating the position of time domain resource within the scheduling window to obtain the position of time domain resource within the scheduling window; and obtaining the position of time domain resource for uplink transmission according to the position of the scheduling window and the position of time domain resource within the scheduling window.

### Embodiment 5

In one embodiment, a method of repeating a physical data channel based on a scheduling window is provided, which may be implemented in conjunction with any one or more of the above-described Embodiments 1, 2, 3, and 4, wherein the method comprises: the physical data channel repeating transmissions on the same set of time domain resource units of the plurality of scheduling windows, and when the number of time domain resource units occupied by the physical data channel in each scheduling window is less than that included in the scheduling window, it is discontinuously repeating. In one embodiment, the physical downlink control channel and the scheduled physical data channel are repeatedly transmitted within a plurality of scheduling windows, and time relationship between the first physical data channel repetition and the last physical downlink control channel repetition is same-window scheduling or cross-window scheduling. In another embodiment, the physical downlink control channel and the scheduled physical data channel are continuously repetitions, and the time relationship between the first physical data channel repetition and the last physical downlink control channel repetition are determined by the scheduling window.

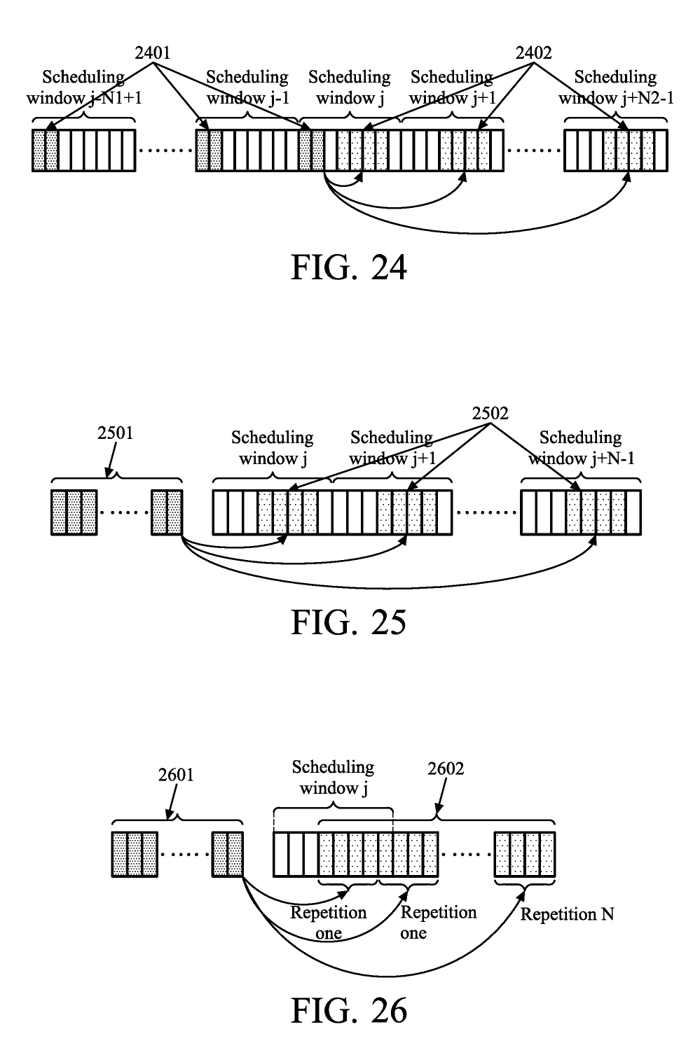

FIG. 24 is a schematic diagram illustrating that both the PDCCH and the scheduled PDSCH are repeatly transmitted in multiple scheduling windows according to an embodiment of the invention. As shown in FIG. 24, each scheduling window may include a physical downlink control area and a physical downlink data area. Therefore, the time domain resource units occupied by the PDCCH or the scheduled PDSCH in each scheduling window is always smaller than the number of time domain resource units included in the scheduling window, that is, PDCCH and PDSCH are intermittently repeated in time. For example, 2401 in FIG. 24 represents an intermittent PDCCH repetition, while 2402 represents an intermittent PDSCH repetition. When the number of repetitions for the PDCCH transmission is N1, the number and position of the time domain resource units occupied by the PDCCH in each scheduling window are the same, and when the number of repetitions for the PDSCH transmission is N2, the number and position of the time domain resource units allocated to the PDSCH in each scheduling window are the same. The first PDSCH repetition and the corresponding last PDCCH repetition belong to a scheduling window.

In another embodiment, the PDSCH in FIG. 24 may also be a PUSCH since the uplink scheduling window contains only the uplink data area, that is, the number of time domain resource units allocated to a PUSCH may be less than or equal to the number of time domain resource units included in the uplink scheduling window. If the number of time domain resource units allocated to a PUSCH is less than the number of time domain resource units included in the uplink scheduling window, PUSCH is discontinuously repeated; or if the number of time domain resource units allocated to a PUSCH equals to the number of time domain resource units included in the uplink scheduling window, PUSCH is continuously repeated. The first PUSCH repetition and the corresponding last PDCCH repetition belong to a different scheduling window, such as two adjacent scheduling windows.

FIG. 25 is a schematic diagram illustrating the continuous repetition of a physical downlink control channel and the discontinuous repetition of the scheduled physical downlink data channel according to an embodiment of the invention, where 2501 represents the continuous PDCCH repetition and 2502 represents the discontinuous PDSCH repetition. The PDCCH is repeated regardless of the scheduling window, and the PDSCH repetition on the same set of time domain resource units in multiple scheduling windows. If the number of time domain resource units allocated by the PDSCH in the scheduling window is smaller than the number of time domain resource units included in the scheduling window, the PDSCH is discontinuously repeated. If the number of time domain resource units allocated by the PDSCH in the scheduling window equals to the number of time domain resource units included in the scheduling window, PDSCH is continuously repeated. The time relationship between the starting subframe of the scheduling window for the first PDSCH repetition and the last PDCCH repetition can be referred to FIG. 12, FIG. 13 and FIG. 14.

FIG. 26 is a schematic diagram illustrating the continuous repetition of both the physical downlink control channel and the scheduled physical downlink data channel according to an embodiment of the invention. The starting position of the first PDSCH repetition is still determined by the scheduling window, that is, the time relationship between the starting subframe of the first PDSCH repetition and the ending subframe of the last PDCCH repetition is determined by the time relationship between the PDCCH and its corresponding scheduling window and the allocation position of the time domain resource units within the scheduling window for the PDSCH, where 2601 in FIG. 26 represents the continuous PDCCH repetition, and 2602 represents the discontinuous PDSCH repetition. The time relationship between the PDCCH and its corresponding scheduling window can be referred to FIG. 12, FIG. 13 and FIG. 14.

Unless otherwise defined, all terms (including technical and scientific terms) used herein are to be construed as being in the art. It will also be understood that commonly used terms should also be construed as being customary in the relevant art, and not as an idealized or too formal implication, unless expressly defined herein.

The wireless communication device may be an electronic device which is used to communicate voice and/or to transmit data to the base station, which may communicate with the network device (e.g., Public Switched Telephone Network (PSTN), Internet and so on). In the communication system and method described in the present invention, the wireless communication device may be referred to as a mobile station, a user equipment (UE), an access terminal, a user using a Subscriber Station, a mobile terminal, a user terminal, a terminal, a user using unit, and the like. For example, the wireless communication device can be a device such as a cellular handheld device, a smart handheld device, a personal digital assistant (PDA), a notebook computer, a Netbook, an electronic reader, a wireless modem and other devices. The term “user equipment (UE)”, “wireless communication device” may be used interchangeably in the present invention, and are denoted as ordinary terms for “wireless communication device”.

Base stations are often referred to as Node Bs, evolved Node Bs (eNBs), enhanced eNBs, Home evolved Node Bs (HeNBs), Home enhanced Node B (HeNBs) or other similar terms. Since the scope of the present invention is not limited to be applied to the cellular mobile communication standard, the terms “base station”, “node B”, “base station” and “home base station” are used interchangeably and are denoted as ordinary terms of “base station” in the present invention. Moreover, the term “base station” may be used to represent an access point. The access point may be an electronic device that provides access to a network (e.g., a local area network (LAN), an Internet, or the like) for a device for wireless communication. The term “communication device” may also be used to represent a wireless communication device and/or a base station.

Exemplary embodiments of the present invention are described in detail and are described below in order to enable those skilled in the art to practice and implement the present invention. Importantly and it should be understood that the exemplary embodiments of the present invention may be embodied in many forms and should not be construed as limited to the exemplary embodiments of the invention set forth herein. Thus, while the invention may be affected by various modifications and alternations, specific embodiments thereof are shown by way of example in the drawings and will be described in detail herein. However, it should be understood that it is not intended to limit to the specific form disclosed in this disclosure. By contrast, the invention will cover all modifications, equivalents, and substitutions within the spirit and scope of the invention. The same reference numerals denote the same elements in the description of the drawings.

1. A transmission method based on a physical downlink channel, the method comprising:
receiving control information carried by the physical downlink channel, the control information including a time interval indication; and
determining information of uplink resource associated with a user equipment or a starting subframe of a scheduling window based on the time interval indication and an ending subframe of the physical downlink channel.

2. The method of claim 1, wherein the control information is Random Access Response (RAR) information and the physical downlink channel is a physical downlink shared channel (PDSCH) carrying the RAR information; and a starting subframe for transmitting a message 3 (MSG3) is determined based on the time interval indication and an ending subframe of the PDSCH.

3. The method of claim 1, wherein the control information is downlink control information for scheduling a physical transport block, the physical downlink channel is a corresponding physical downlink control channel (PDCCH) carrying the downlink control information, and the downlink control information contains a resource allocation (RA) field indicating a set of time domain resource units within the scheduling window; and receiving or transmitting the physical transport block on the set of time domain resource units indicated by the RA field.

4. The method of claim 3, wherein the starting subframe of the scheduling window is determined by the ending subframe of the corresponding physical downlink control channel carrying the downlink control information and the time interval indication, or by an ending subframe of the physical downlink control channel search space containing the downlink control information and the time interval indication; or the starting subframe of the scheduling window is determined by an ending subframe including a physical downlink control area of the downlink control information and the time interval indication.

5. The method of claim 3, wherein the time domain resource unit is a subframe or a plurality of subframes; the time domain resource unit is a time slot or a plurality of time slots.

6. The method of claim 3, wherein the set of time domain resource units indicated by the RA field are continuous.

7. The method of claim 3, wherein the scheduling window includes a subframe which is unavailable for resource allocation or the scheduling window excludes the subframe which is unavailable for resource allocation; and the subframe which is unavailable for resource allocation is indicated in the system information block(SIB).

8. The method of claim 3, wherein the starting subframe of the scheduling window is determined by a subframe number, a frame number, and a number of subframes included in the scheduling window.

9. The method of claim 8, wherein a plurality of scheduling windows included in a given time are numbered and the numbering of the scheduling window is used in the initialization of a scrambling sequence generator used for physical data channel transmission.

10. The method of claim 9, wherein each downlink time domain scheduling window containsthe physical downlink control area and a physical downlink data area.

11. The method of claim 10, wherein the physical downlink control channel and a set of time domain resource units scheduled thereby belong to the same or a different scheduling window.

12. The method of claim 3, wherein the number of subframes contained in the downlink scheduling window is different from the number of subframes contained in the uplink scheduling window; or a duration of the downlink scheduling window is different from a duration of the uplink scheduling window.

13. A user equipment based on a physical downlink channel, comprising:
a wireless transceiver configured to perform wireless transmission with at least one base station;
a controller connected to the wireless transceiver, the controller is configured to receive control information carried by a physical downlink channel from the at least one base station, the control information including a time interval indication; and
wherein the controller determines information of uplink resource associated with the user equipment or a starting subframe of a scheduling window based on the time interval indication and an ending subframe of the physical downlink channel.

14. The user equipment of claim 13, wherein the control information is Random Access Response (RAR) information and the physical downlink channel is a physical downlink shared channel(PDSCH) carrying the RAR information; and the controller further determines a starting subframe for transmitting a message 3 (MSG3) based on the time interval indication and an ending subframe of the PDSCH.

15. A base station based on a physical downlink channel, comprising:
a wireless transceiver configured to perform wireless transmission with at least one user equipment; and
a controller connected to the wireless transceiver, the controller is arranged in control information carried by the physical downlink channel to indicate a time interval indication such that the at least one user equipment determines information of uplink resource associated with the at least one user equipment or a starting subframe of the scheduling window based on the time interval indication in the control information and an ending subframe of the physical downlink channel.

16. The base station of claim 15, wherein the control information is random access response (RAR) information and the physical downlink channel is a physical downlink shared channel(PDSCH) carrying the RAR information; and a starting subframe of a message 3 (MSG3) received by the wireless transceiver is determined by the time interval indication and an ending subframe of the PDSCH.
